(19) United States
(12) Patent Application Publication
(10) Pub. No.: US 2026/0194450 A1
(43) Pub. Date: Jul. 9, 2026

(54) THREE-DIMENSIONAL CONTOURED SCANNING PHOTOACOUSTIC IMAGING AND VIRTUAL STAINING

(71) Applicant: California Institute of Technology, Pasadena, CA (US)

(72) Inventors: Lihong Wang, Arcadia, CA (US); Rui Cao, Pasadena, CA (US)

(73) Assignee: California Institute of Technology, Pasadena, CA (US)

(21) Appl. No.: 19/389,908

(22) Filed: Nov. 14, 2025

Related U.S. Application Data
(62) Division of application No. 17/820,496, filed on Aug. 17, 2022, now Pat. No. 12,504,363.
(60) Provisional application No. 63/234,080, filed on Aug. 17, 2021.

(51) Int. Cl. G01N 21/17; G06V 10/82; G06V 20/69; H04N 13/15; H04N 13/254; H04N 13/271

(52) U.S. Cl. CPC G01N 21/1702; G06V 10/82; G06V 20/69; H04N 13/15; H04N 13/254; H04N 13/271; G01N 2021/1706; G01N 2021/1772; G01N 2201/067; G01N 2201/106; G01N 2201/127

(57) ABSTRACT

Methods, devices, apparatus, and systems for three-dimensional (3D) contoured scanning photoacoustic imaging and/or deep learning virtual staining.

### CROSS-REFERENCES TO RELATED APPLICATIONS

This application is a divisional of U.S. patent application Ser. No. 17/820,496, filed on Aug. 17, 2022, which claims priority to and the benefit of U.S. Provisional Patent Application No. 63/234,080, titled “Label-Free Three-Dimensional Contoured scanning Ultraviolet Photoacoustic Microscopy For Inoperative Diagnosis” and filed on Aug. 17, 2021; which are hereby incorporated by reference in their entireties and for all purposes.

### FEDERALLY SPONSORED RESEARCH OR DEVELOPMENT

This invention was made with government support under Grant No. EB028277 awarded by National Institute of Health (NIH). The government has certain rights in the invention.

### FIELD

Certain aspects pertain generally to photoacoustic imaging, and more particularly to methods and systems that implement three-dimensional contoured scanning photoacoustic imaging and/or virtual staining that can be employed in applications such as, for example, pathology.

### BACKGROUND

Approximately 18.1 million new cancer cases were diagnosed worldwide in 2018, and the number of new cancer cases per year is expected to rise to 29.5 million, with 9.6 million cancer-related deaths by 2040 as discussed in “World Health Organization Global Cancer Observatory,” Retrieved from Internet <http://gco.iarc.fr/today/home> [Retrieved May 19, 2021]. Despite advances in cancer treatment, surgery remains the cornerstone, and more than 80% of cancer patients have a surgical procedure at some point as discussed in Wyld, L., Audisio, R. A. & Poston, G. J., “The evolution of cancer surgery and future perspectives, Nat Rev Clin Oncol 12, 115-124 (2015) and Sullivan, R. et al., “Global cancer surgery: delivering safe, affordable, and timely cancer surgery,” The Lancet Oncology 16, 1193-1224 (2015).

In oncology surgery, intraoperative pathology provides surgical guidance and identification of tumor margin as discussed in, for example, Mahe, E. et al., “Intraoperative pathology consultation: error, cause and impact,” Can J Surg 56, E13-E18 (2013). The border of the removed tumor tissue is often examined by intraoperative frozen section to ensure negative margins, meaning normal tissue surrounding the resected tumor as discussed in DiNardo, L. J., Lin, J., Karageorge, L. S. & Powers, C. N., “Accuracy, utility, and cost of frozen section margins in head and neck cancer surgery,” Laryngoscope 110, 1773-1776 (2000). Most localized tumors with negative margin resection show much better outcomes and a lower chance of tumor recurrence. The intraoperative evaluation of tumor margin allows confirmation of complete tumor resection before oncology surgeons close the surgical wound and helps patients avoid an additional tumor resection surgery.

### SUMMARY

Certain aspects pertain to three-dimensional (3D) contoured scanning photoacoustic imaging and/or virtual staining methods, apparatus, and systems.

In one aspect of the present disclosure, a three-dimensional contoured scanning photoacoustic apparatus is disclosed. In some embodiments, the three-dimensional contoured scanning photoacoustic apparatus includes: an optical system configured to direct at least a first portion of a pulsed laser beam to a specimen being imaged; an ultrasonic transducer device configured to detect one or more photoacoustic signals induced by the at least the first portion of the pulsed laser beam; and a three-dimensional contour scanner configured to scan the specimen and/or the ultrasonic transducer device to compensate in real-time for three-dimensional contour in a surface of the specimen using time of flight data of the one or more photoacoustic signals.

In another aspect of the present disclosure, a photoacoustic method is disclosed. In some embodiments, the photoacoustic method is a three-dimensional contoured scanning photoacoustic method, which includes real-time three-dimensional contoured photoacoustic scanning of a surface of a specimen using time of flight data.

In another aspect of the present disclosure, a method of virtually staining one or more histology images is disclosed. In some embodiments, the method includes: training a first machine learning model; inputting, to the trained first machine learning model, a second histology image obtained using a first histological technique; and generating, using the trained first machine learning model, a virtually stained histology image based on the second histology image, the virtually stained histology image having a characteristic of the second histological technique.

In some variants, the training of the first machine learning model is performed by: inputting a first histology image obtained using the first histological technique to the first machine learning model to generate a first predicted image having a characteristic of a second histological technique; inputting the first predicted image to a second machine learning model configured to generate a second predicted image having a characteristic of the first histological technique; and based on an error associated with the first histology image and the second predicted image, updating one or both of the first machine learning model or the second machine learning model.

In another aspect of the present disclosure, a method for virtually staining a photoacoustic histology image is disclosed. In some embodiments, the method includes generating a virtually stained histology image using a first generative adversarial network trained to predict, from the photoacoustic histology image, a stained histology image having a characteristic of hematoxylin and eosin staining, the virtually stained histology image having the characteristic of hematoxylin and eosin staining.

These and other features are described in more detail below with reference to the associated drawings.

### BRIEF DESCRIPTION OF THE DRAWINGS

FIG. 1 is a block diagram of components of an example of a 3D contoured scanning ultraviolet photoacoustic imaging (UV-PAM) system, according to various embodiments.

FIG. 2 is a schematic diagram of components of an example of a 3D contoured scanning ultraviolet photoacoustic imaging (UV-PAM) system, according to some embodiments.

FIG. 3 is an example of images of one domain (e.g., stained histology images) generated by machine learning models (e.g., first and second generators G and F) trained in conjunction with corresponding machine learning models (e.g., discriminators D_{HE} and D_{PA}), based on images of another domain (e.g., UV-PAM images).

FIG. 4 is a detailed diagram of an example architecture of generators and corresponding discriminators of a cycle-consistent generative adversarial network (CycleGAN), according to some embodiments.

FIG. 5 is a flow diagram illustrating an example method of training a first machine learning model to virtually stain one or more histology images, according to some embodiments.

FIG. 6 is a flow diagram illustrating a method of virtually staining one or more histology images, according to some embodiments.

FIG. 7 is a flow diagram illustrating a method of virtually staining one or more histology images, according to some embodiments.

FIG. 8 is a schematic diagram depicting workflows of both an example of UV-PAM photoacoustic histology according to some embodiments and traditional H&E staining histology of bone specimens for comparison.

FIG. 9 is a flowchart illustrating an example of a UV-PAM method, according to various embodiments.

FIG. 10 is a schematic illustration of time-of-flight, surface curve, and compensation steps at two scanning positions, according to various embodiments.

FIG. 11A is a photograph of a side view and a second photograph of a top view of a normal bone specimen.

FIG. 11B is a photograph of a side view of a bone specimen extracted from the right proximal femur with grade 3 chondrosarcoma.

FIG. 11C is a photograph of a side view of a bone specimen with metastatic differentiated adenocarcinoma, consistent with the known thyroid primary.

FIG. 12A is a photograph of a curved surface made of black tape.

FIG. 12B is a 3D plot of an example of 3D curved surface profile of the black tape in FIG. 12A as acquired by a UV-PAM system, according to some embodiments.

FIG. 12C is a 3D plot of an example of the relative distances between the focal plane and the 3D curved surface profile of the black tape in FIG. 12A as acquired by a UV-PAM system, according to some embodiments.

FIG. 13A is an example image of the undecalcified left tibia bone specimen acquired by 2D raster scanning without contour compensation.

FIG. 13B is an example image of the undecalcified left tibia bone specimen acquired by 3D contour scanning by 3D contour-scanning, according to some embodiments.

FIG. 13C is a 3D plot of an example of a scanning profile acquired by 2D raster scanning.

FIG. 13D is a 3D plot of an example of a scanning profile acquired by 3D contour-scanning, according to some embodiments.

FIG. 13E is an example image of a normal unprocessed thick bone sample acquired by 2D raster scanning without contour compensation.

FIG. 13F is an example image of a normal unprocessed thick bone sample acquired by 3D contour scanning, according to some embodiments.

FIG. 14A is an example image of the undecalcified thick bone specimen from a normal area acquired by 3D contour scanning using 3D contour-scanning UV-PAM system, according to some embodiments.

FIG. 14B is an example image of the undecalcified thick bone specimen with an area with metastasized cancer acquired by 3D contour scanning using 3D contour-scanning UV-PAM system, according to some embodiments.

FIG. 15 depicts example images of decalcified bone specimens acquired by 3D contour scanning using 3D contour-scanning UV-PAM system, according to some embodiments.

FIG. 16 depicts additional example images of the decalcified bone specimens acquired by 3D contour scanning using 3D contour-scanning UV-PAM system, according to some embodiments.

FIG. 17A is an example 3D contour-scanning UV-PAM image of a decalcified bone specimen from a patient with moderately differentiated metastatic pulmonary adenocarcinoma in original grayscale contrast, according to some embodiments.

FIG. 17B is another example 3D contour-scanning UV-PAM image of the decalcified bone specimen of FIG. 17A in reversed grayscale contrast, according to some embodiments.

FIG. 18A is an example 3D contour-scanning UV-PAM image in reversed grayscale contrast of a decalcified bone specimen extracted from a patient with metastatic adenocarcinoma, according to some embodiments.

FIG. 18B is an example H&E image corresponding to the UV-PAM image of FIG. 18A.

FIG. 18C is an example 3D contour-scanning UV-PAM image in reversed grayscale contrast of the decalcified bone specimen of FIG. 18B with normal bone fragment and hematopoietic marrow, according to some embodiments.

FIG. 18D is an example H&E image corresponding to the UV-PAM image of FIG. 18B.

FIG. 19A is an example 3D contour-scanning UV-PAM image in reversed grayscale contrast of an undecalcified bone specimen, according to some embodiments.

FIG. 19B is another example 3D contour-scanning UV-PAM image in reversed grayscale contrast of the undecalcified bone specimen of FIG. 19A, according to some embodiments.

FIG. 19C is another example 3D contour-scanning UV-PAM image in reversed grayscale contrast of the undecalcified bone specimen of FIG. 19A.

FIG. 19D is an example H&E image corresponding to the UV-PAM image of FIG. 19A.

FIG. 19E is an example H&E image corresponding to the UV-PAM image of FIG. 19B.

FIG. 19F is an example H&E image corresponding to the UV-PAM image of FIG. 19C.

FIG. 20 depicts example images of decalcified bone slice with high-grade osteosarcoma from the femur acquired by 3D contour scanning using 3D contour-scanning UV-PAM system, according to some embodiments, and some corresponding H&E close-up images.

FIG. 21 depicts example 3D contour scanning UV-PAM grayscale images and corresponding virtually stained color UV-PAM images according to some embodiments, and also H&E images of an undecalcified bone fragment specimen, according to some embodiments.

The figures and components therein may not be drawn to scale. Various components of the figures described herein may not be drawn to scale.

The patent or application file contains at least one drawing executed in color. Copies of this patent or patent application publication with color drawing(s) will be provided by the Office upon request and payment of the necessary fee.

### DETAILED DESCRIPTION

Different aspects are described below with reference to the accompanying drawings. The features illustrated in the drawings may not be to scale. In the following description, numerous specific details are set forth in order to provide a thorough understanding of the presented implementations. The disclosed implementations may be practiced without one or more of these specific details. In other instances, well-known operations have not been described in detail to avoid unnecessarily obscuring the disclosed implementations. While the disclosed implementations will be described in conjunction with the specific implementations, it will be understood that it is not intended to limit the disclosed implementations.

### I. Introduction

To provide intraoperative pathological examination and guide tumor resection, oncology surgeons currently use the frozen section technique, which typically takes a small portion of tissue and freezes the tissue in a cryostat machine. The frozen tissue is then cut into thin sections (5-8 μm) using a microtome or cryostat and is stained for direct examination under a microscope. The need for sectioning the specimen into thin slices prevents this technique from being used on hard tissues and may also cause inevitable tissue loss. For instance, the intraoperative diagnosis of calcified bone (e.g., cortical bone and calcified tumors) cannot be evaluated by the frozen section technique due to ossification. It is almost impossible to directly cut undecalcified bone tissue into slices thin enough for traditional pathological examination. The original bone tissue must instead undergo a decalcification process that can take up to several days, which may introduce artifacts if under-decalcified or over-decalcified. Moreover, the procedures for acquiring pathological diagnosis of the calcified bone requires highly trained specialists and are labor-intensive and time-consuming.

The lack of intraoperative pathological diagnosis techniques, particularly for bone tissue, has been a long-standing challenge. For orthopedic oncologists resecting primary bone tumors, the need for time-consuming decalcification procedures can mean that no adequate pathological analysis during the operation. Thus, surgeons tend toward wider margins based on pre-surgical imaging of bone tumors rather than intraoperative tissue analysis. Although wider margins are desirable for local tumor control, the functional loss can be much greater if those margins include vital structures such as tendons, nerves, blood vessels, or joints. Many surgeons use 2 centimeters as the ideal bony margin and measure this off the pre-operative imaging, while a meta-analysis performed in 2019 showed that a 2 millimeter margin is sufficient to avoid local recurrence as discussed in Gomez-Brouchet, A. et al., “Assessment of resection margins in bone sarcoma treated by neoadjuvant chemotherapy: Literature review and guidelines of the bone group (GROUPOS) of the French sarcoma group and bone tumor study group (GSF-GETO/RESOS),” Orthopaedics & Traumatology: Surgery & Research 105, 773-780 (2019).

Since calcified primary bone tumors, such as osteosarcoma, present most commonly in a periarticular location, 1.8 centimeters of margin difference could lead to joint salvage, increased patient bone stock for any future surgery needed, and less morbidity. A modality that allows for fast, accurate intraoperative bony margin analysis would be an invaluable tool in limb-salvage surgery. In recent years, rapid developments of imaging techniques have revolutionized many biological and biomedical areas as well as pathology. Multiple fluorescence microscopy methods have been demonstrated for diagnostic imaging, including confocal microscopy, wide-field structured-illumination microscopy (SIM), light-sheet microscopy, and microscopy with UV surface excitation (MUSE). However, these fluorescence microscopy techniques require dye staining of the specimen to provide image contrast, which involves complicated and different additional procedures for various samples prior to imaging and needs highly experienced personnel. Some label-free optical imaging techniques have been developed for intraoperative pathological diagnoses, such as stimulated Raman scattering microscopy and coherence tomography/microscopy (OCT/OCM). However, these techniques require a flat surface within the field of view (FOV) to ensure that the imaging plane is located around the optical focal plane for high-resolution imaging. Flatness is difficult to achieve in calcified bone tumors resected during operation, as cutting hard and calcified bone inevitably leads to rough surfaces.

Generally speaking, the intraoperative pathologic examination of bone is challenging for orthopedic oncologists due to the difficulty of performing bone frozen sections. The calcification of bone tissue prevents smooth slicing of the specimen, while the time-consuming decalcification process can take up to 7 days. Orthopedic oncologists can use pre-operative computed tomography (CT) scans or magnetic resonance imaging (MRI) to identify the bony edge of resection. However, CT scans and MRI do not allow accurate diagnosis or intraoperative confirmation of tumor margins, leading to wider bone margins in bony sarcomas (typically 2 cm from the tumor). Depending on the anatomic location, a wide margin in multiple directions can potentially lead to significant functional morbidity.

Certain techniques disclosed herein relate generally to 3D contoured scanning ultraviolet photoacoustic imaging (UV-PAM) systems and methods. UV-PAM techniques can be used to image rough contoured surfaces of unprocessed thick samples like bone, which can be challenging for traditional histological techniques. UV-PAM systems include a 3D contoured scanner that enables scanning the specimen with real-time contour compensation based on time-of-flight information of photoacoustic signals. The 3D contoured scanner may be employed to generate consistent and optical diffraction-limited resolution within a full field of view (FOV) of the specimen being imaged, which does not require prior knowledge of sample surface profiles. UV-PAM techniques use ultraviolet (UV) light to illuminate the surface of the specimen being imaged. While penetration depth of UV light depends on the type of the specimen, for some bone specimens, the penetration of UV light is generally less than acoustical resolution so that no deep photoacoustic signal is generated and mixed with surface signals, which allows for direct imaging of the surfaces. Various embodiments described herein include devices, systems, methods, processes, and the like. UV-PAM techniques may be used to, for example, provide real-time 3D contoured scanning of unprocessed thick samples.

Certain techniques disclosed herein relate generally to methods of virtual staining one or more grayscale images (also sometimes referred to herein as “virtual staining methods”). The virtual staining methods may be deep-learning-based employing, for example, unsupervised or supervised deep learning techniques. The virtual staining methods may be used to perform virtual staining (e.g., virtual Hematoxylin and Eosin (H&E) staining) of grayscale histological images that can provide a pathologist with complementary contrast and help interpret the images. In some implementations, virtual staining methods that employ unsupervised deep learning techniques may be used. Different from supervised deep learning, as might use generational adversarial networks (GANs), an unsupervised deep learning based virtual staining method may be based on cycle consistent generational adversarial networks (CycleGANs) that do not require coupled pairs of stained and unstained images. This avoids the need for well-aligned UV-PAM and stained images for neural network training, which can be challenging to acquire due to artifacts caused by sample preparation induced morphology changes.

Certain techniques disclosed herein relate generally to 3D contoured scanning ultraviolet photoacoustic imaging (UV-PAM) methods and systems that employ virtual staining. These UV-PAM techniques may be used as, for example, a tool for label-free (e.g., no physical staining) intraoperative diagnosis of challenging tissues such as thick calcified bone specimens. For example, these UV-PAM techniques may be used to perform label-free imaging and intraoperative diagnosis of thick unprocessed bone, which requires minimal tissue preparation. The capability of these UV-PAM techniques to image a non-sectioned bone specimen allows for direct visualization of well-preserved structure and composition of calcifications, which could potentially make these UV-PAM techniques an ideal tool for intraoperative pathological diagnosis. Since these UV-PAM techniques can perform label-free photoacoustic (PA) histology of bone that avoids the need for excessive tissue processing (i.e., decalcification and sectioning) and H&E staining, these techniques can be employed to perform rapid intraoperative diagnoses of unprocessed bone specimens, which may improve orthopedic oncology surgery. Moreover, since no physical sectioning is needed, it does not need highly specific trained technicians for bone specimen preparation and the undestructed bone specimen can be further examined by other techniques after UV-PAM imaging.

### II. 3D Contoured Scanning Ultraviolet Photoacoustic Imaging (UV-PAM) Systems

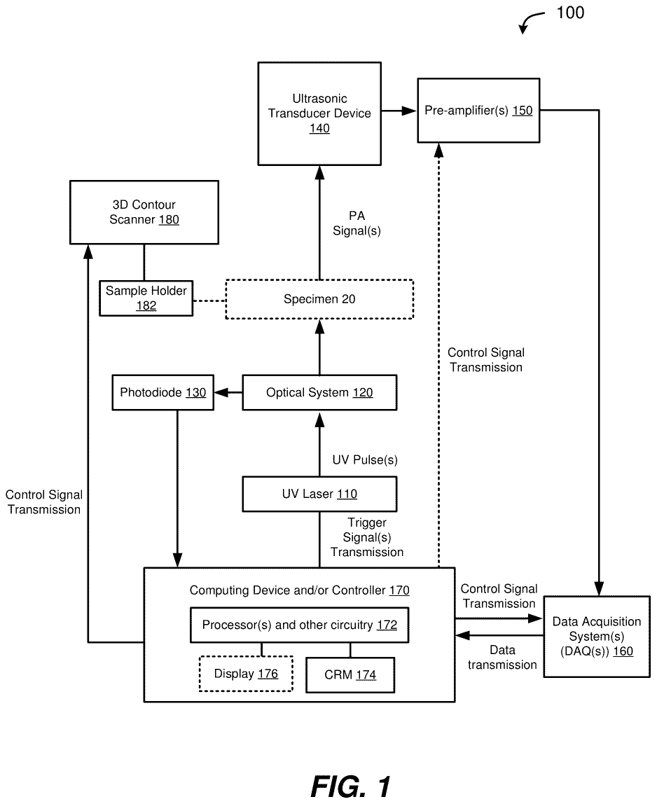

FIG. 1 is a block diagram of components of an example of a 3D contoured scanning ultraviolet photoacoustic imaging (UV-PAM) system 100, according to various embodiments. UV-PAM system 100 includes an ultraviolet (UV) laser 110 (e.g., a pulsed UV laser) that can generate a pulsed or modulated ultraviolet laser beam and an optical system 120 in communication with ultraviolet (UV) laser 110 to receive the pulsed or modulate ultraviolet laser beam. UV-PAM system 100 also optionally (denoted by dashed line) includes a specimen 20. It would be understood that in FIG. 1 and other illustrated examples, the UV-PAM system is shown during a 3D contoured scanning process where a specimen being imaged is located on a specimen receiving device of the UV-PAM system. At other instances such as during a virtual staining process, the UV-PAM system may not include the specimen. While FIG. 1 shows an example of components of UV-PAM 100, any number of these components may be included in UV-PAM 100, or any of the components may be omitted. For example, in some configurations, UV-PAM 100 may not include display 176. In alternative configurations, different or additional components may be included in UV-PAM 100.

Returning to FIG. 1, optical system 120 is also configured to propagate at least a portion of the pulsed or modulated ultraviolet light beam from UV laser 110 to specimen 20. UV-PAM system 100 also includes a photodiode 130 in communication with optical system 120. Optical system 120 is also configured to propagate at least a portion of the pulsed or modulated ultraviolet light beam from UV laser 110 to photodiode 130. Photodiode 130 is configured to take measurements of pulse energy of the pulsed or modulated ultraviolet light beam. The photodiode measurements may be used to compensate for pulse-to-pulse fluctuation.

UV-PAM system 100 also includes an ultrasonic transducer device 140 that may be coupled to or otherwise in acoustic communication with specimen 20 to receive one or more photoacoustic signals. In addition, UV-PAM system 100 includes one or more pre-amplifiers 150 in communication with ultrasonic transducer device 140 to adjust amplification of the one or more photoacoustic signals received from ultrasonic transducer device 140. UV-PAM system 100 also includes one or more data acquisition systems (DAQs) 160 in communication with one or more pre-amplifiers 150 to digitize and/or record the amplified photoacoustic signal(s).

UV-PAM system 100 also includes a 3D contoured scanner 180 for scanning specimen 20 and/or ultrasonic transducer device 140 to compensate in real-time for contour changes in the surface of the specimen 20 during a 3D contoured scanning process. For example, 3D contoured scanner 180 may scan specimen 20, by moving sample holder 182 with specimen 20 thereon, along a trajectory based on a profile surface curve of specimen 20 to specimen 20 at, or near, the focal plane of the ultrasonic transducer device 140. The profile surface curve may be determined in real-time from time-of-flight data of photoacoustic signal(s) detected by ultrasonic transducer device 140. 3D contoured scanner 180 includes, or is operatively coupled to, a sample holder 182 for receiving and holding specimen 20 during the 3D contoured scanning process. The 3D contoured scanner 180 may include, for example, a 3-axis motorized stage for moving the specimen 20 and/or ultrasonic transducer device 140 along three axes. In some cases, 3D contoured scanner 180 may be configured to maintain consistent lateral resolution within the field-of-view being imaged.

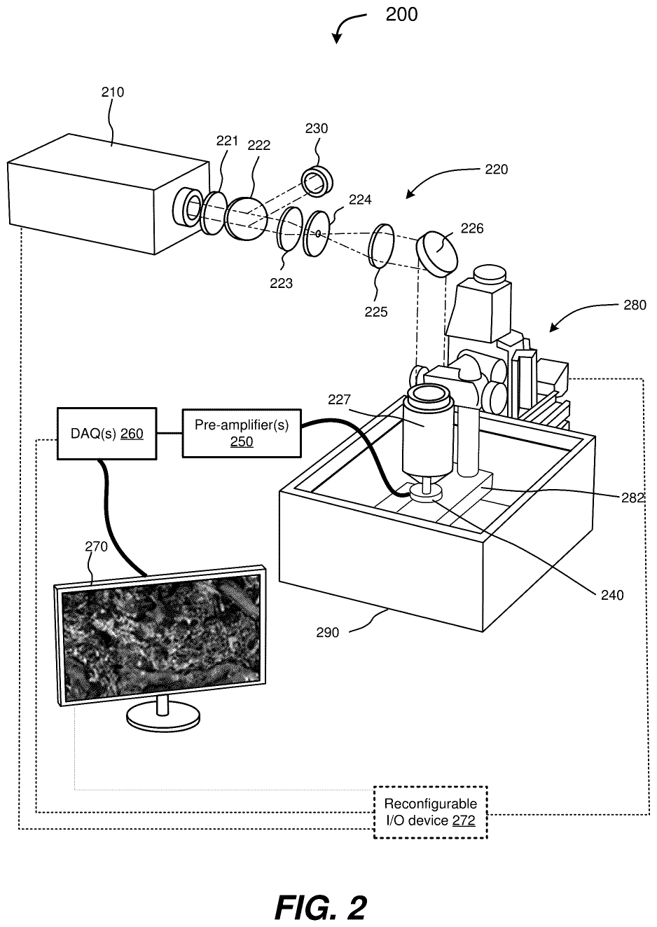

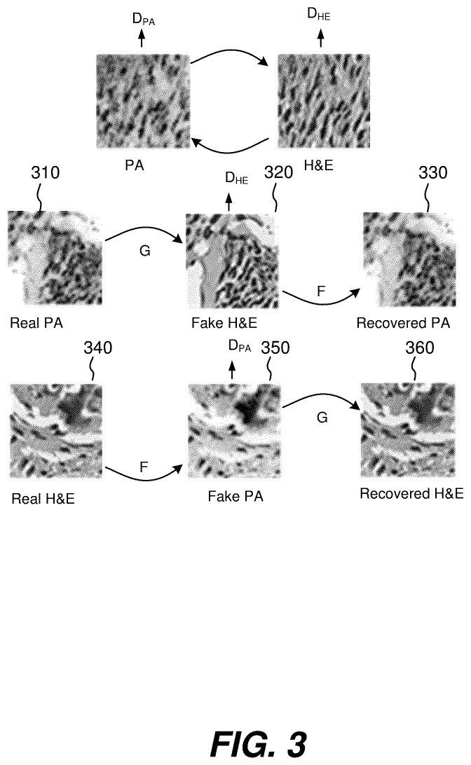

In various embodiments, a UV-PAM system includes a 3D contoured scanner (e.g., 3D contoured scanner 180 in FIG. 1 and 3D contoured scanner 280 in FIG. 2) that includes, or is operably coupled to, a sample holder for holding (e.g., mounting) the specimen during a 3D contoured scanning process. The 3D contoured scanner is configured to compensate in real-time for contour changes in the surface of the specimen using time-of-flight data of photoacoustic signal(s). For example, the 3D contoured scanner may scan the specimen along a trajectory corresponding to a surface profile curve of the specimen to keep the specimen at, or near, the focal plane of the ultrasonic transducer device. The surface profile curve of the specimen may be determined in real-time from time-of-flight data of photoacoustic signals detected by the ultrasonic transducer device during a two-dimensional scan of the specimen. The trajectory of the 3D contoured scanner may be determined in real time from compensation steps calculated from a difference between the focal length of the ultrasonic transducer device and the surface profile curve.

The 3D contoured scanner may include one or more devices for movement in three dimensions. Some examples of such devices include linear actuators, linear ball screw assemblies, linear stages, step motors, and motorized scanning stages. For example, in one implementation, the 3D contoured scanner includes a 3-axis motorized stage with three (3) step motors. An example of a step motor is PLS-85, PI Micos motor sold by GmbH. The 3D contoured scanner may implement a point moving average to generate a smooth scanning trajectory. For example, to try to avoid potential noise interference and remove outliers, at least a 100-point moving average may be used. Although some examples are described herein with respect to moving the specimen receiving device, in another implementation, 3D contoured scanner may move the ultrasonic transducer device and/or the specimen receiving device during the 3D contoured scanning process.

Returning to FIG. 1, UV-PAM system 100 also includes a computing device and/or a controller 170 having one or more processors or other circuitry 172, an optional display 176 in electrical communication with the processor(s) 172, and a computer readable medium (CRM) 174 in electronic communication with the processor(s) 172. The computing device may be, for example, a personal computer, an embedded computer, a single board computer (e.g. Raspberry Pi or similar), a portable computation device (e.g., tablet), a controller, or any other computation device or system of devices capable of performing the functions described herein. Computing device and/or controller 170 is in electronic communication with UV laser 110 to receive trigger signals that laser pulses have been sent or to transmit trigger signals to active UV laser 110. Computing device and/or controller 170 is also in electrical communication with DAQ(s) 160 to receive data transmissions and/or to send control signal(s). Optionally (denoted by dashed line), computing device and/or controller 170 is also in electronic communication with the one or more pre-amplifiers 150 to send control signal(s), e.g., to adjust amplification. The processor(s) 172 are in electrical communication with the CRM 174 to store and/or retrieve data such as the photoacoustic signal data. The processor(s) 172 are in electrical communication with optional display 176 to send display data. The electrical communication links between system components of UV-PAM system 100 may be in wired and/or wireless form. The electrical communication links may be able to provide power in addition to communicating signals in some cases.

According to certain implementations, UV-PAM system 100 is configured to operate in a reflection mode to, for example, image thick unprocessed biological samples. An example of a UV-PAM system configured to operate in reflection mode is shown in FIG. 2. In other implementations, such as a multichannel parallel imaging example with a microlens array, UV-PAM system 100 may be configured to operate in transmission mode.

According to various embodiments, a UV-PAM system includes an ultrasonic transducer device (e.g., ultrasonic transducer device 140 in FIG. 1 or ultrasonic transducer device 240 in FIG. 2) that may be acoustically coupled to the specimen during the 3D contoured scanning process. For example, an acoustic medium such as an acoustic gel, water, or other medium capable of conveying ultrasound pulses, is provided at least partially between the specimen being imaged and the ultrasonic transducer device. The ultrasonic transducer device may be acoustically coupled to the specimen to be able to detect photoacoustic waves induced by laser pulses. The ultrasonic transducer device may then sample the photoacoustic signal or photoacoustic signals. The detected photoacoustic signal(s) may be indicative of the optical absorption of the specimen by the UV laser pulses.

According to certain aspects, the ultrasonic transducer device includes a ring-shaped ultrasonic transducer with a central aperture. FIG. 2 includes an example of an ultrasonic transducer device 240 including a ring-shaped ultrasonic transducer (e.g., 42 MHz center frequency, 76%-6 dB two-way bandwidth) with a central aperture. This central aperture allows for confocal alignment of the optical and acoustic foci in reflection mode. The UV laser beam may pass through the central aperture for confocal alignment.

In some embodiments, the ultrasonic transducer device only includes, or uses, a single transducer element having a numerical aperture and a depth-of-field (DOF). In one implementation, an ultrasonic transducer device includes a single transducer element with a numerical aperture of about 0.16 and a DOF of about 9 μm, which corresponds to 6 ns ultrasound propagation for the speed of sound at 1500 m/s in room-temperature water. In other embodiments, the ultrasonic transducer device includes a plurality of transducer elements operable to collect multiple photoacoustic signals in parallel. For example, the ultrasonic transducer device may be in the form of an ultrasonic transducer array having an array of transducer elements (e.g., two-dimensional array or three-dimensional array). Each transducer element in the array has an aperture (e.g., a flat-rectangular aperture) with a height and a width or pitch. The width or pitch may be about 1.35 mm in one aspect. The width or pitch may be in a range of 1.20 mm to 1.50 mm in another aspect. The height may be about 5 mm in one aspect. The height may be in a range of 2 mm to 10 mm in another aspect.

During the 3D contoured scanning process, the specimen and the ultrasonic transducer device may be in contact with an acoustic medium. For example, the specimen and/or the ultrasonic transducer device may be at least partially immersed in the acoustic medium. For example, the UV-PAM system may include a tank at least partially filled with acoustic medium such as a water tank (e.g., water tank 190 in FIG. 2) in which the specimen and/or the ultrasonic transducer device are at least partially immersed in order make acoustic contact via the acoustic medium.

In various embodiments, a UV-PAM system includes an optical system (e.g., optical system 120 in FIG. 1 and optical system 220 in FIG. 2) for propagating and/or altering the pulsed or modulated ultraviolet beam from an ultraviolet (UV) laser and directing at least a portion of the beam to a specimen being imaged during a 3D scanning operation of the UV-PAM system. The optical system includes one or more optical components (e.g., lens(es), microlens arrays, optical filter(s), mirror(s), beam steering device(s), beam-splitter(s), beam sampler(s), optical fiber(s), pinhole(s), relay(s), and/or beam combiner(s)) that are configured to propagate and/or alter the UV beam.

In one embodiment, an UV-PAM system may employ multichannel parallel imaging to increase imaging speed. For example, multiple UV focal spots and an ultrasonic transducer device with an array of transducer elements may be implemented. For example, the UV-PAM system may include an optical system with a microlens array to create multiple focal spots. Given the generally limited numerical aperture and a short working distance of microlens arrays, this UV-PAM system may operate in the transmission mode.

In various embodiments, the UV-PAM system may include a photodiode (e.g., photodiode 130 in FIG. 1 or photodiode 230 in FIG. 2) for measuring pulse energy of one or more ultraviolet pulses generated by the UV laser. The pulse energy measured by the photodiode (e.g., photodiode 130 in FIG. 1 or photodiode 230 in FIG. 2) may be used to normalize the photoacoustic amplitude and compensate for the laser pulse fluctuation (pulse-to-pulse fluctuation compensation). An example of a photodiode that can be implemented is a Si photodiode such as the PDA36A photodiode sold by Thorlabs.

In various embodiments, the UV-PAM system may include an ultraviolet laser (e.g., UV laser 110 in FIG. 1 and UV laser 210 in FIG. 2) or other ultraviolet light source that can generate pulsed or modulated illumination. In certain implementations, the ultraviolet light source is in the form of a pulsed UV laser such as, for example, an Nd: YLF (neodymium-doped yttrium lithium fluoride) Q-switched 266 nm nanosecond pulsed laser such as, e.g., the QL266-010-O CrystaLaser® laser. In one aspect, the pulse repetition rate may be about 10 kHz. In another aspect, the pulse repletion rate may be about 50 kHz (e.g., with a RPMC laser). In yet another aspect, the pulse repetition rate may be up to 200 kHz, for example, with a customized RPMC. Although certain examples of UV-PAM systems are described herein with a single UV laser or other UV source, in other implementations, multiple UV lasers may be used. With multiple lasers, image acquisition may be accelerated.

Although certain examples of UV-PAM systems and apparatus are described as employing a UV laser for emitting one or more UV pulses, in other implementations, another light source may be included. For example, UV-PAM system 100 in FIG. 1 or the UV-PAM system 200 in FIG. 2 may include a pulsed laser for emitting one or more ultraviolet pulses and/or one or more pulses of another wavelength. For example, the light source may be a tunable laser. Depending on the illumination wavelength, various contrasts may be imaged by these implementations, including but not limited to hemoglobin, DNA/RNA, cytochrome, water, lipid, and protein.

In various embodiments, the UV-PAM system includes a computing device and/or a controller (e.g., computing device and/or a controller 170 in FIG. 1, computing device 270 in FIG. 2, and reconfigurable I/O device 272). The computing device and/or controller includes one or more processors and other circuitry, a computer readable media (CRM), and an optional display. One or more processors may execute instructions stored on the CRM to perform one or more operations of the UV-PAM system. For example, the one or more processors of the UV-PAM system and/or one or more external processors may execute instructions for one or more of 1) determining and communicating control signals to system components, 2) performing 3D contoured scanning, 3) performing reconstruction algorithm(s) to reconstruct grayscale images of the specimen using photoacoustic signal data, and 4) performing virtual staining of grayscale images. For example, the processor(s) 172 in FIG. 1 and/or one or more external processors may execute instructions that communicate control signals to the 3D contoured scanner 180 to move sample holder 182 for 3D contoured scanning of specimen 20 and send signals with instructions to DAQ(s) 160 to simultaneously record photoacoustic signals received by ultrasonic transducer device 140. In one implementation, the controller is a reconfigurable I/O device (e.g., myRIO-1900 sold by National Instruments) with a field-programmable gate array (FPGA) that may be used to control and/or synchronize one or more components of the UV-PAM system. For example, UV-PAM system 200 in FIG. 2 includes an optional reconfigurable I/O device 272 that may synchronize UV laser pulses from the UV laser 210, motor movements of 3D contoured scanner 280, and data acquisition by one or more DAQ(s) 260.

In some embodiments, the UV-PAM system may include one or more communication interfaces (e.g., a universal serial bus (USB) interface). Communication interfaces can be used, for example, to connect various peripherals and input/output (I/O) devices such as a wired keyboard or mouse or to connect a dongle for use in wirelessly connecting various wireless-enabled peripherals. Such additional interfaces also can include serial interfaces such as, for example, an interface to connect to a ribbon cable. It should also be appreciated that the various system components can be electrically coupled to communicate with various components over one or more of a variety of suitable interfaces and cables such as, for example, USB interfaces and cables, ribbon cables, Ethernet cables, among other suitable interfaces and cables.

In one aspect, digitized radio frequency data from one or more DAQs (e.g., DAQs 160 in FIG. 1 and DAQs 260 in FIG. 2) is first stored in an onboard buffer, and then transferred to the computing device (e.g., computing device 180) through a universal serial bus. The DAQs may be configured to record photoacoustic signals within a certain time (e.g., 10 μs) after each laser pulse excitation. For example, digitized radio frequency data from one or more DAQs may be stored on an onboard buffer, and then transferred to the computing device through a universal serial bus 2.0. In this example, the DAQs are configured to record photoacoustic signals within 10 μs after each laser pulse excitation. In another example, digitized radio frequency data from one or more DAQs may be stored on an onboard buffer, and then transferred to the computing device through a universal serial bus 3.0. In this example, the DAQs are configured to record photoacoustic signals within 200 μs after each laser pulse excitation.

In certain embodiments, the UV-PAM system may also include one or more pre-amplifiers (e.g., pre-amplifier(s) 150 in FIG. 1 and pre-amplifier(s) 250 in FIG. 2) and/or one or more one or more data acquisition systems (DAQs) (e.g., DAQ(s) 160 in FIG. 1 and DAQ(s) 260 in FIG. 2). In one implementation, two low noise amplifiers are used such as, for example, ZFL-500LN+ amplifiers sold by Mini-Circuits. The pre-amplifier(s) is in electrical communication with the ultrasonic transducer device to be able to receive photoacoustic signals. The pre-amplifier(s) can be employed to boost the photoacoustic signals received from the ultrasonic transducer device. The DAQ(s) is in electrical communication with the pre-amplifier(s) to be able to receive the amplified photoacoustic signals. The DAQ(s) may process the photoacoustic signals by, for example, digitizing and/or recording the photoacoustic signal. In certain aspects, the DAQ(s) include at least one digitizer. For example, a DAQ may include a data acquisition card (e.g., ATS 9350 waveform digitizer sold by AlazarTech) for digitizing the photoacoustic signal. The photoacoustic signal may be digitized at, for example, a 500 MHz sampling rate.

Returning to FIG. 1, UV-PAM system 100 may perform a UV-PAM imaging method including a 3D contoured scanning process and an image reconstruction process to form one or more UV-PAM grayscale images. In addition or alternatively, UV-PAM system 100 may perform a deep learning virtual staining techniques to convert one or more grayscale images (e.g., the one or more UV-PAM grayscale images) into pseudocolor virtually stained histology images. Examples of deep learning virtual staining techniques are described in Section IV. Prior to performing 3D contoured scanning, the optical and acoustic foci are confocally aligned, while the propagation time of the acoustic signal from the optical focus is recorded to determine the focal spot position.

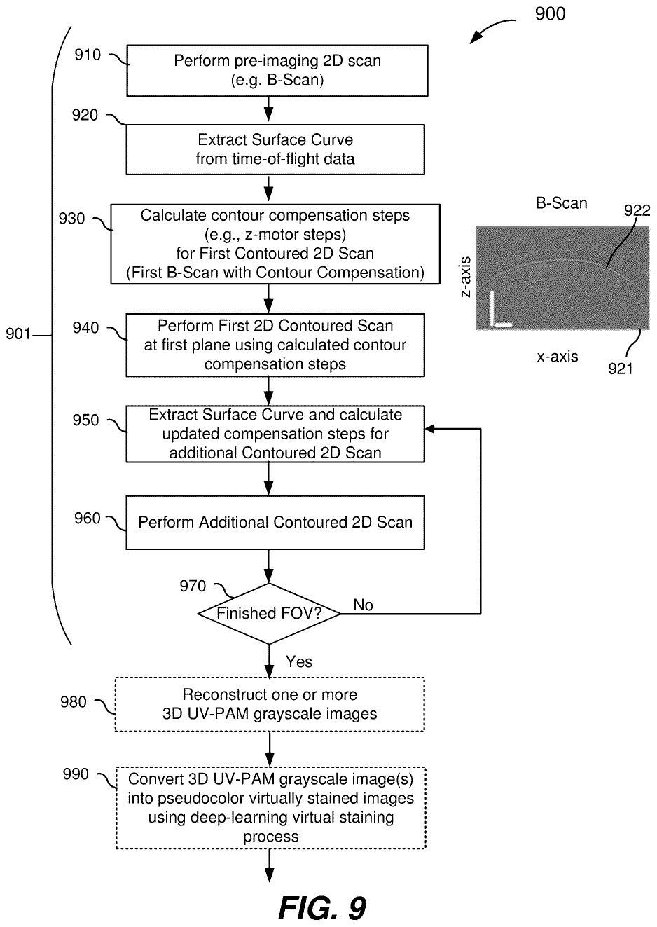

In one example of a 3D contoured scanning process, 3D contoured scanner 180 moves sample holder 182 with specimen 20 along a trajectory in two directions simultaneously (e.g., along x-axis and z-axis FIG. 9) for each of a plurality of 2D contoured scans while ultrasonic transducer device 140 detects one or more photoacoustic signals induced by excitation from one or more ultraviolet pulses. There may be a small step (e.g., about 0.625 μm) between adjacent 2D contoured scans. Due to this small step, the trajectory may be set to follow the surface profile from a previous contoured scan or in the case of the first contoured scan, the trajectory may be set to follow the surface profile determined from a first seed scan. The trajectory may be determined from contour compensation steps calculated using time-of-flight information from the one or more photoacoustic signals. To extract the ultrasound propagation time (time of flight), the center of positive and negative peak positions in photoacoustic A-line signals may be calculated, which is converted to the sample position to determine the time of flight at each scanning position. The trajectory of the 3D contoured scanner 180 may be used to scan along the contour of the 3D surface of specimen 20 positioning specimen 20 at, or approximately at, the focal plane of the ultrasonic transducer device 140 for each scanning position determined from the A-line signals. An example of operations of a 3D contoured scanning process 901 is shown in FIG. 9. During 3D contoured scanning, DAQ(s) 160 records and/or digitizes the photoacoustic signals detected by ultrasonic transducer device 140 and amplified by pre-amplifier(s) 150. The photoacoustic signals are recorded at a sampling frequency (e.g., 500 MHz), which is determined by settings of DAQ(s) 160.

UV-PAM system 100 may synchronize UV laser pulses emitted by UV laser 110, motor movements of the 3D contoured scanner 180, and data acquisition by the one or more DAQ(s) 160. For example, UV-PAM system 100 may include a controller in the form of a reconfigurable I/O device (e.g., myRIO-1900 sold by National Instruments) with a field-programmable gate array (FPGA) that may be used to control and synchronize UV laser pulses from UV laser 110, motor movements of the 3D contoured scanner 180, and data acquisition by the one or more DAQ(s) 160.

During image construction, the computing device and/or controller 170 may use amplitude data from the photoacoustic signal(s) from the plurality of 2D contoured scans to generate one or more UV-PAM grayscale images of the specimen. To reconstruct the 3D UV-PAM grayscale images, the photoacoustic amplitude of each A-line signal (signal at each scanning position) of each two-dimensional contoured scan may be calculated after the Hilbert transform. The pulse energy measurements taken by photodiode 130 may be used to normalize the photoacoustic amplitude and compensate for laser pulse fluctuation in the UV laser pulses from UV laser 110. The axial position (e.g. z-position in scan 921 in FIG. 9) of the specimen surface is calculated by detecting the peak of the A-line signal after the Hilbert transform. Each UV-PAM grayscale image is a 2D MAP (maximum amplitude projection) image that is self-normalized. Since the photoacoustic amplitude of the contrast is proportional to its absorption cross-section, it may be used to effectively differentiate cell nuclei, cytoplasm, and the background. The cell nuclei have the largest absorption coefficient at 266 nm and the highest PA signals.

After constructing the one or more UV-PAM grayscale images, optionally a trained neural network may be used in a deep learning virtual staining process to convert the one or more UV-PAM grayscale images into pseudocolor virtually stained histology images. Examples of virtual staining techniques are described in Section IV.

To allow imaging of the rough surface of unprocessed thick samples like bone, contoured scanning without prior knowledge of the sample surface may be implemented using a 3D contoured scanner including, for example, a 3-axis motorized stage, which ensures consistent lateral resolution within a large field of view. For consistent and optical resolution, the distance between the sample and optical focus may be maintained within the DOF during scanning. In contoured scanning, the time-of-flight information of photoacoustic signals may be used to calculate the distance between the sample and the focal spot, which can be adjusted by the 3D contoured scanner during contoured scanning.

FIG. 2 is a schematic diagram of components of an example of a UV-PAM system 200, according to embodiments. UV-PAM system 200 includes an ultraviolet (UV) laser 110 for emitting a pulsed ultraviolet laser beam, an optical system 220, and a photodiode 230 for measuring pulse energy. In one implementation, UV laser 210 is a Nd: YLF (neodymium-doped yttrium lithium fluoride) Q-switched 266 nm nanosecond pulsed laser (e.g., QL266-010-O pulsed laser sold by CrystaLaser). UV-PAM system 200 also includes an ultrasonic transducer device 240 with a ring-shaped transducer for detecting one or more photoacoustic signals, one or more pre-amplifiers 250 for amplifying the photoacoustic signals from the ultrasonic transducer device 240, one or more DAQ(s) 260 for digitizing and/or recording the amplified photoacoustic signals from or more pre-amplifiers 250, and a computing device 270. In addition, UV-PAM system 200 includes a 3D contoured scanner 280 including a sample holder 282 for receiving and holding a specimen being imaged and a water tank 290. While FIG. 2 shows a UV-PAM system 200 with certain components, any number of these components may be included in UV-PAM system 200, or any of the components may be omitted. In alternative implementations, different or additional components may be included in UV-PAM system 200.

In FIG. 2, optical system 220 includes a band pass filter 221 (e.g., FGUV5 band pass filter sold by Thorlabs) in communication with UV laser 210 for receiving the UV laser beam and for spectrally filtering out green light. Optical system 220 also includes a beam sampler 222 (e.g., a UV fused silica beam sampler such as, for example, BSF10-UV beam sampler sold by Thorlabs) in communication with a band pass filter 221, a first lens 222 (e.g., a first plano-convex lens), a pinhole 224 (e.g., a 15 μm high-energy pinhole such, for example, 900PH-15 pinhole sold by Newport) for creating single mode light, a second lens 225 (e.g., a second plano-convex lens), a mirror 226, and a water immersion UV objective 227. In one implementation, the water immersion UV objective 227 includes an aspheric lens, a concave lens, and at least one convex lens (e.g., NT49-696, NT48-674, and/or NT46-313 lenses sold by Edmund Optics) with a numerical aperture (NA) of 0.16. With a numerical aperture of 0.16, the depth of field of UV-PAM 200 may be about 9 μm, which corresponds to 6 ns ultrasound propagation for the speed of sound at 1500 m/s in room-temperature water.

The beam sampler (BS) 222 is placed before the first lens 222 to redirect a first portion (e.g., about 3-5%) of the laser beam to photodiode 230 (e.g., a Si photodiode such as, for example, PDA36A photodiode sold by Thorlabs) for measuring pulse energy. The photodiode measurements may be used to compensate for pulse-to-pulse energy fluctuation. The beam sampler (BS) 222 is also configured to direct a second portion of the laser beam to the first lens 222. The laser beam may be spatially filtered and expanded by the first lens 222, the second lens 225, and the pinhole 224. The mirror 226 is configured to receive the collimated and expanded beam from the second lens 225 and reflect the collimated and expanded beam to the water-immersed objective 227.

The water immersion objective 227 is configured to focus the collimated and expanded beam through the ring-shaped transducer of the ultrasonic transducer device 240 to illuminate the specimen being imaged for photoacoustic excitation. The ring-shaped ultrasonic transducer device 240 (e.g., a ring-shaped ultrasonic transducer device having a 42 MHz center frequency and 76%-6 dB two-way bandwidth) has a central aperture that can detect the photoacoustic signal. This central aperture allows for confocal alignment of the optical and acoustic foci in reflection mode. The focused laser beam from water immersed objective 227 passes through the central aperture for confocal alignment. The ring-shaped ultrasonic transducer device 240 is configured to detect the photoacoustic signal. UV-PAM system 200 is configured to detect photoacoustic signal(s) in the reflection mode.

One or more pre-amplifiers 250 (e.g., two low noise amplifiers such as, for example, ZFL-500LN+ amplifiers sold by Mini-Circuits) are in communication with the ring-shaped ultrasonic transducer device 240 for receiving the photoacoustic signal(s) and for amplifying the signal(s). DAQ(s) 260 are in communication with one or more pre-amplifiers 250 to receive the amplified photoacoustic signal(s). DAQ(s) 260 include a data acquisition card (e.g., ATS 9350 waveform digitizer sold by AlazarTech) for digitizing the amplified photoacoustic signal(s) at, for example, a 500 MHz sampling rate. The computing device 270 is in communication with DAQ(s) 260 to receive the digitized photoacoustic data. UV-PAM 200 also includes an optional (denoted by dashed line) reconfigurable I/O device 272 (e.g., myRIO-1900 device sold by National Instruments) with a field-programmable gate array (FPGA) that may be employed to control and/or synchronize laser pulses from UV laser 210, motor movements of 3D contoured scanner 280, and data acquisition by DAQ(s) 260. Reconfigurable I/O device 272 is in communication with computing device 270, DAQ(s) 260, UV laser 210, and 3D contoured scanner 280.

The sample holder 282 may receive a specimen being imaged and/or hold the specimen while immersed in acoustic fluid (e.g., water) in tank 290. The ring-shaped ultrasonic transducer device 240 is also immersed in the acoustic fluid during data acquisition. The sample holder 282 may be an integral component of the 3D contoured scanner 280 or may be a separate component coupled to 3D contoured scanner 280. In one implementation, the 3D contoured scanner 280 includes 3 step motors such as, for example, PLS-85, PI Micos motors sold by GmbH. During the contoured scanning process, the immersed specimen mounted onto the sample holder 282 is scanned.

The computing device 270 may have one or more processors or other circuitry, a display in electrical communication with the processor(s), and a computer readable medium (CRM) in electronic communication with the processor(s). The processor(s) may be in electrical communication with the CRM to store and/or retrieve data such as the photoacoustic signal data. The computing device 270 may be, for example, a personal computer, an embedded computer, a single board computer (e.g., Raspberry Pi or similar), a portable computation device (e.g., tablet), a controller, or any other computation device or system of devices capable of performing the functions described herein. Reconfigurable I/O device 272 is in electronic communication with UV laser 210, DAQ(s) 260, and 3D contour scanner 280 to transmit control signals. Computing device 270 is in electrical communication with DAQ(s) 260 to receive data transmissions. The electrical communication links between components of UV-PAM system 200 may be in wired and/or wireless form. The electrical communication links may be able to provide power in addition to communicate signals in some cases.

In an exemplary operation of UV-PAM system 200, prior to imaging, the optical and acoustic foci may be confocally aligned, while the propagation time of the acoustic signal from the optical focus may be recorded to determine the focal spot position. To extract the ultrasound propagation time, the center of positive and negative peak positions in PA A-line signals may be calculated, which is then converted to the sample position. Without prior knowledge of the sample surface profile, one seed two-dimensional scan (e.g., B-scan) with the z-motor of the 3D contoured scanner 180 is disabled or not used may be implemented to calculate the starting contour trajectory. To avoid potential noise interference and remove outliers, a 100-point moving average may be used to generate a smooth z scanning trajectory. During the contoured scanning, both the x-axis motor and the z-axis motor of the 3D contoured scanner 280 move simultaneously. After the first contoured B-scan, the z-motor trajectory and the distance between the sample surface and the ultrasonic transducer device 240 are calculated and used to compute the accurate surface profile. Due to the small step between adjacent 2D scans (e.g., step of about 0.625 μm), the second z-motor trajectory can be set to follow the surface profile from the previous contoured scan. Then, the surface profile is updated according to the second contoured scan. This process is repeated until the scanning of the entire field-of-view is complete. Real-time data processing and system control are implemented using MATLAB and Lab VIEW hybrid programming.

UV-PAM system 200 may perform a UV-PAM imaging method including a 3D contoured scanning process and an image reconstruction process to form one or more UV-PAM grayscale images. In addition or alternatively, UV-PAM system 200 may perform a deep learning virtual staining techniques to convert one or more grayscale images (e.g., the one or more UV-PAM grayscale images) into pseudocolor virtually stained histology images. Examples of deep learning virtual staining techniques are described in Section IV. Prior to performing 3D contoured scanning, the optical and acoustic foci are confocally aligned, while the propagation time of the acoustic signal from the optical focus is recorded to determine the focal spot position.

In one example of a 3D contoured scanning process, 3D contoured scanner 280 moves sample holder 282 with the specimen along a trajectory in two directions simultaneously (e.g., along x-axis and z-axis FIG. 9) for each of a plurality of 2D contoured scans while ultrasonic transducer device 240 detects one or more photoacoustic signals induced by excitation from one or more ultraviolet pulses. There may be a small step (e.g., about 0.625 μm) between adjacent 2D contoured scans. The trajectory may be set to follow the surface profile from a previous contoured scan or in the case of the first contoured scan, the trajectory may be set to follow the surface profile determined from a first seed scan. The trajectory may be determined from contour compensation steps calculated using time-of-flight information from the one or more photoacoustic signals. To extract the ultrasound propagation time (time of flight), the center of positive and negative peak positions in photoacoustic A-line signals may be calculated, which is converted to the sample position to determine the time of flight at each scanning position. The trajectory of the 3D contoured scanner 280 may be used to scan along the contour of the 3D surface of the specimen positioning the specimen at, or approximately at, the focal plane of the ultrasonic transducer device 240 for each scanning position determined from the A-line signals. An example of operations of a 3D contoured scanning process 901 is shown in FIG. 9. During 3D contoured scanning, DAQ(s) 260 records and/or digitizes the photoacoustic signals detected by ultrasonic transducer device 240 and amplified by pre-amplifier(s) 250. The photoacoustic signals are recorded at a sampling frequency (e.g., 500 MHz), which is determined by settings of DAQ(s) 260. Reconfigurable I/O device 272 may control and synchronize UV laser pulses from UV laser 210, motor movements of the 3D contoured scanner 280, and data acquisition by the one or more DAQ(s) 260.

During image construction, computing device 270 may use amplitude data from the photoacoustic signal(s) from the plurality of 2D contoured scans to generate one or more UV-PAM grayscale images of the specimen. To reconstruct the UV-PAM grayscale images, the photoacoustic amplitude of each A-line signal (signal at each scanning position) of each two-dimensional contoured scan may be calculated after the Hilbert transform. The pulse energy measurements taken by photodiode 230 may be used to normalize the photoacoustic amplitude and compensate for laser pulse fluctuation in the UV laser pulses from UV laser 210. The axial position (e.g. z-position in scan 921 in FIG. 9) of the specimen surface is calculated by detecting the peak of the A-line signal after the Hilbert transform. Each UV-PAM grayscale image is a 2D MAP (maximum amplitude projection) image that is self-normalized. Since the photoacoustic amplitude of the contrast is proportional to its absorption cross-section, it may be used to effectively differentiate cell nuclei, cytoplasm, and the background. The cell nuclei have the largest absorption coefficient at 266 nm and the highest PA signals.

After constructing the one or more UV-PAM grayscale images, optionally a trained neural network may be used in a deep learning virtual staining process to convert the one or more UV-PAM grayscale images into pseudocolor virtually stained histology images. Examples of virtual staining techniques are described in Section IV.

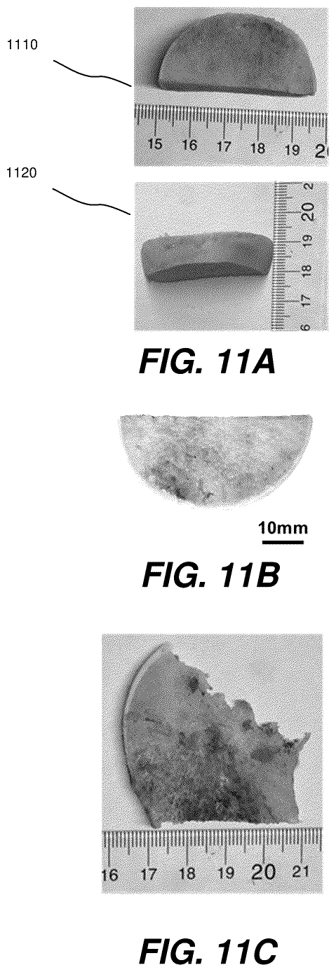

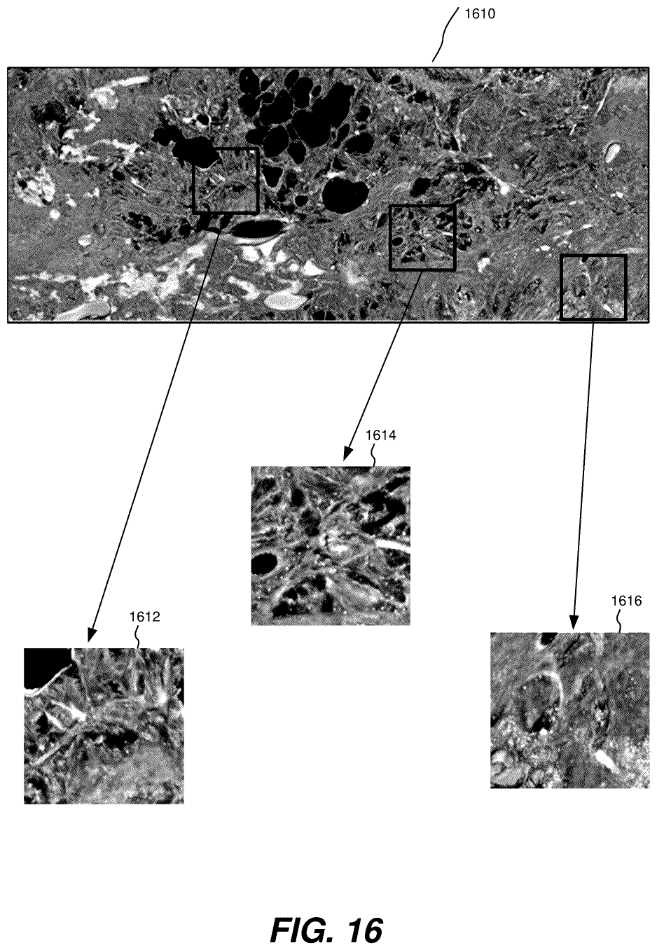

With optical focusing and the time-of-flight information from the one or more photoacoustic signals, UV-PAM images may provide contrast in 3D. In one implementation of the UV-PAM system 200, ultrasonic transducer device 240 includes a 42 MHz ultrasonic transducer and DAQ(s) 260 includes a data acquisition card sampling at 500 MHz. In this implementation, UV-PAM system 200 may be able to localize the z positions of the sample surface with an accuracy finer than the acoustical resolution (~40 μm) by approximately a factor of 10 as limited by the signal-to-noise ratio. The UV-PAM system 200 may employ a 266 nm nanosecond pulsed laser to image the DNA/RNA. While the penetration depth depends on the sample type, in bone specimens, the UV light penetration may be less than the acoustical resolution. Thus, no deep photoacoustic signal is generated and mixed with surface signals, allowing for direct imaging of the surfaces of, for example, thick biological tissues. While soft tissue can be sampled or squeezed with a flat surface, unprocessed hard tissues such as the calcified bone specimens shown in FIGS. 11A, 11B, and 11C usually have a rough surface due to tissue extraction. FIG. 16A includes a first photo 1110 of a side view and a second photo 1120 of a top view of a normal bone specimen. FIG. 11B is a photo of a side view of a bone specimen extracted from the right proximal femur with grade 3 chondrosarcoma. FIG. 11C is a photo of a side view of a bone specimen with metastatic poorly differentiated adenocarcinoma, consistent with the known thyroid primary.

The 3D contour-scanning UV-PAM 100 system in FIG. 1 and 3D contour-scanning UV-PAM 200 system of FIG. 1 may allow for direct imaging of thick specimens with rough surfaces, which provide the possibility of intraoperative pathologic diagnosis of undecalcified thick bone. Since the height differences in adjacent 2D contour scan (B-scan) positions (e.g., about 0.625 μm away from each other) can be reasonably assumed to be much smaller than the depth of focus (DOF) of the UV-PAM (~9 μm), the z contour-scanning trajectory can be predicted and updated in real-time after the first seed B-scan for the full field-of-view (FOV), without the prior knowledge of the surface contour, for example, as describe with reference to FIG. 9. Thus, 3D contoured scanning UV-PAM systems described herein may provide the possibility of ensuring the distance between the image position and the focal plane is within the DOF, resulting in a consistent diffraction-limited lateral resolution for rough surface imaging.

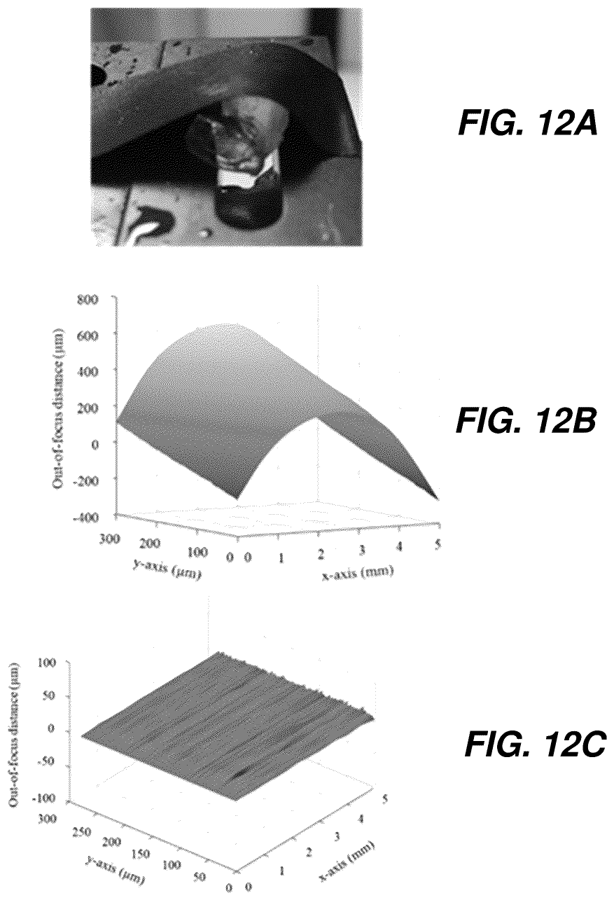

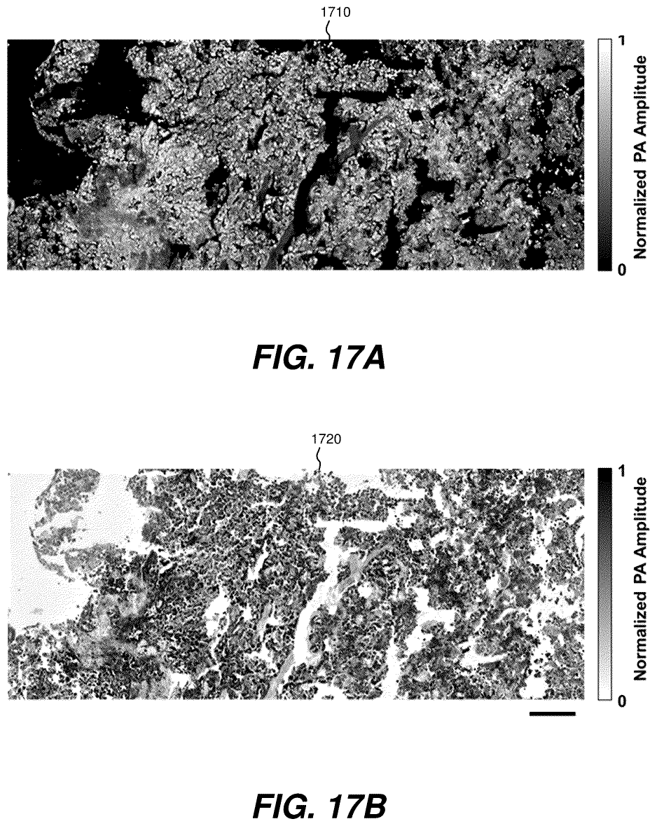

A plot of the 3D surface profile of a 3D curved surface of black tape and a plot of the relative distance between the 3D curved surface and the focal plane as determined by UV-PAM system 200 are shown in FIGS. 17B and 17C, which show well-compensated distances in the full FOV. FIG. 12A is a photograph of a curved surface made of black tape. FIG. 12B is a plot of a 3D curved surface profile of the black tape in FIG. 12A as determined by UV-PAM system 200 of FIG. 2. FIG. 12C is a plot of the relative distance between the focal plane and the 3D curved surface profile of the black tape in FIG. 12A as determined by UV-PAM system 200 of FIG. 2.

After acquiring one or more grayscale UV-PAM images of the sample surface, deep learning techniques (which may be based on generative adversarial networks, for example, as shown in FIG. 3) may be used to implement the virtual staining. In some embodiments, a deep learning network architecture for virtual staining may include one or more generators and corresponding adversarial discriminators.

### III. Generative Adversarial Networks (GANs)

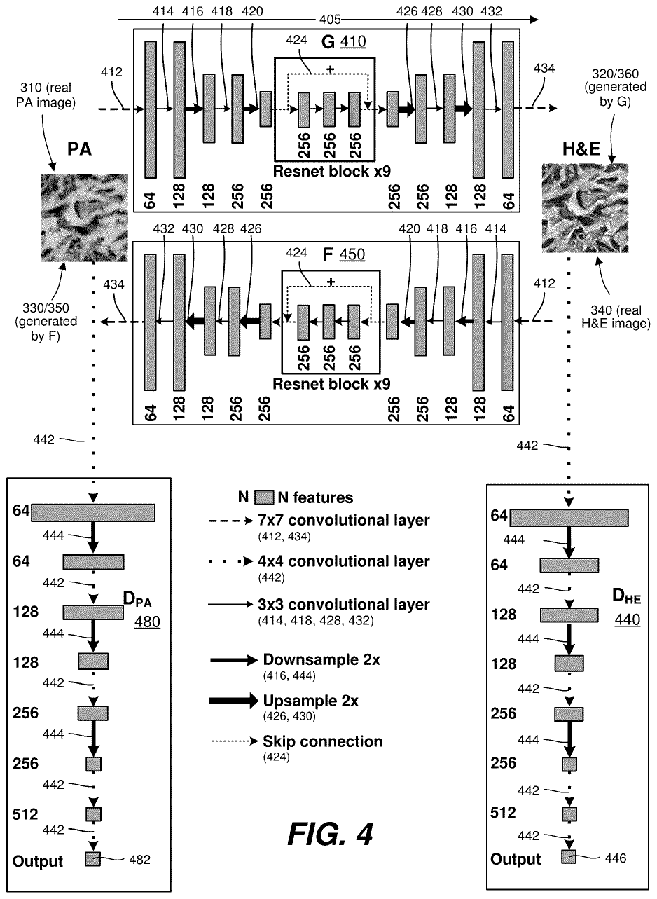

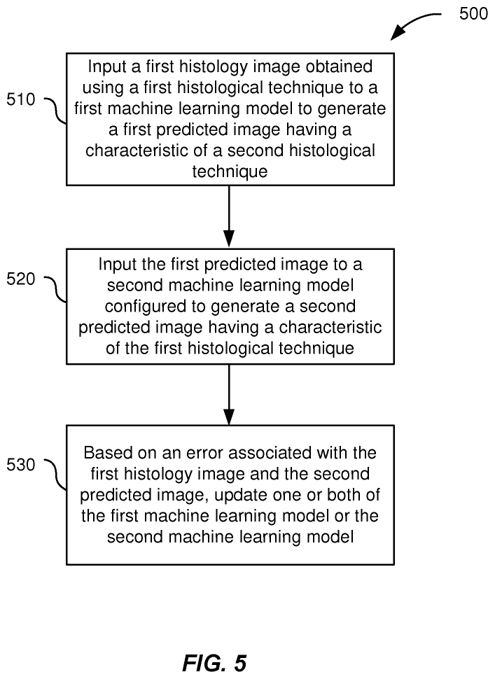

As shown in FIG. 3, two generators G and F and corresponding adversarial discriminators D_{HE} and D_{PA} make up a deep learning architecture that can be used with, e.g., virtual staining of histology images. As discussed below with respect to FIGS. 4 and 5, each generator and discriminator can be trained so that the outputs of G and F are indistinguishable from real H&E and PAM images, respectively. That is, G and D_{HE} may make up a first generative adversarial network (GAN), and F and D_{PA} may make up a second GAN. More specifically, and as will be detailed below, the output (the predicted image) of G based on a histology image 310 (e.g., obtained using a first histological technique such as PA histology) may be evaluated by D_{HE}, which may be a classifier with a sigmoid output which determines whether the predicted image 320 is a real H&E image or a fake H&E image. The generators are further regularized using the cycle-consistency loss; transforming an image from one domain (e.g., PA to H&E) and back should recover the original input (e.g., H&E to PA). FIG. 3 illustrates an example of using a trained generator G to produce an H&E image 320 from a real UV-PAM image 310, and then using generator F to recover a UV-PAM image 330 (which should look substantially similar to and resemble the real UV-PAM image 310). Similarly, generator F can be used to trained to produce a predicted UV-PAM image 350 from a real H&E image 340, and then generator G can be used to recover an H&E image 360 that looks substantially similar to the real H&E image. D_{PA} may be a classifier with a sigmoid output which determines whether the predicted UV-PAM image 350 is a real UV-PAM image or a fake UV-PAM image. This process ensures that the transformations are bijective and produce corresponding morphology. With neural network well trained, it takes less than 5 seconds to virtually stain an image of 1600×1600 pixels.

These two generator-discriminator pairs may each be involved in a GAN, and when implemented together, make up a “cycle-consistent” GAN. Cycle consistency may refer to a characteristic of the GAN in which when an image output by the first generator G based on an original image is used as input to the second generator F, and the output of the second generator F should match the original image. Each GAN is an unsupervised image translation model that can be trained using unpaired collections of images from two different domains, without ground-truth labels. This cycle consistency is particularly useful for generating images in one domain or type or obtained using one histological technique (e.g., UV-PAM images obtained using, e.g., PAM) to images in another domain or type or obtained using another histological technique (e.g., stained images obtained using, e.g., H&E staining techniques) without actually using the other histological technique, which may advantageously save significant time and resources.

FIG. 4 illustrates a more detailed diagram of an example architecture of generators (G and F) and corresponding discriminators (D_{HE} and D_{PA}) of a cycle-consistent generative adversarial network, according to some embodiments.

To effectuate the cycle consistency, generators (e.g., G and F) and discriminators (e.g., D_{HE} and D_{PA}) may be iteratively trained under adversarial loss conditions. A cycle-consistency loss may be determined during training of the generator and discriminator models, and the loss may be used to update one or more parameters (e.g., weight, learning rate, regularization rate) associated with the models using forward and backward propagation.

First generator and discriminator: For example, a first machine learning model (e.g., generator G 410) may receive, as input, a first image from a first domain (e.g., a real PA histology image 310, or a “fake” PA histology image 330 or 350 with an appearance or characteristic of a real PA histology image). In some cases, the input image may have a defined image patch size, such as 70×70, 512×512, or 1024×1024 pixels. The patch size may be selected based on a compromise between promoting high spatial frequency fidelity and avoiding tiling artifacts. Generator G 410 may generate or predict an output image in a second domain (e.g., predicted H&E histology image 320).

The predicted output image may be generated via one or more layers 405 of the neural network of the machine learning model. As an aside, a “layer” may refer herein to a group of nodes of a neural network which are used for a particular task. Some or all nodes of a layer may contain data, such as values, weights, null data, etc., and may form, individually or in combination, vertices and matrices. In some embodiments, layers 405 may include one or more convolutional layers, one or more layers that downsample image data, one or more layers that upsample image data, and/or one or more skip connections.

More specifically, the generator G 410 may include convolution layers 412, 414 configured to perform convolutions to generate a convolutional representation. A convolution may refer to application of a filter to an input (e.g., image data, pixel values) that results in a representation of the input. For example, a convolutional neural network (CNN) may be implemented. In some cases, the convolutional representation may be a feature map having 64 features, 128 features, etc. The convolutional representation may be a set of pixel values determined based on the product of the pixel values of the input image and a filter (also referred to as a “kernel”). The kernel may be a matrix, e.g., a 7×7 matrix having constant values. Or, in some implementations or in addition, a 3×3 convolution kernel may be applied. In FIG. 4, the convolutional layer 412 may be a 7×7 convolutional layer, and the convolutional layer 414 may be a 3×3 convolutional layer. However, it is recognized that other kernel sizes may be selected. In other implementations, additional or fewer kernels may be used. The kernel may take “strides” or steps of one pixel as it moves along the image. As used herein, a “stride” may refer to a parameter utilized to indicate a number of pixels over which the kernel matrix traverses over a training image. Larger values of the stride correspond to skipping over larger numbers of pixels, and vice versa. A larger stride may generate a more compressed image of a given layer of a network relative to a smaller stride. In some examples, the stride may be an integer value, such as 1, 2, 3, 5, etc.

In some embodiments, generator G 410 may include additional layers that result in downsampling 416 of the convolutional representation (e.g., a convoluted image output from the convolutional layer 412). For instance, the additional layers of generator G 410 may include a normalization layer, which may be configured to normalize the output of the previous layer (the convolutional representation). In some implementations, instance normalization may be used with the normalization layer. In other cases, the normalization layer may be configured to perform batch normalization, weight normalization, layer normalization, group normalization, or weight standardization.

The additional layers may include an activation layer. In some implementations, the activation layer may be configured to perform Rectified Linear Unit (ReLU) activation on the normalized feature map. ReLU activation may refer to introduction of non-linearity, useful for backpropagation of errors when training a neural network. That is, all the negative values in the convolutional representation (e.g., a feature map) are replaced with zeroes, resulting in deactivation of a node if the output of the linear transformation is less than 0. Such functionality may be represented as ReLU(x)=max(0, x). In some implementations, other types of ReLU functionality may be used. For example, Leaky ReLU may also be used, which has a small positive slope in the negative area. Such functionality may be represented as, for example, LReLU(x)=αx for x<0; x for ≥0. α may be a fractional value, e.g., 0.1, 0.01. Other examples include Parametric ReLU (PReLU) and Exponential Linear Unit (ELU).

The additional layers may include a pooling layer, which may be configured to reduce the dimensionality of each rectified feature map from the activation layer, while retaining the most important information. In some implementations, max pooling may be used, which may refer to defining a spatial neighborhood from a rectified feature map (e.g., a 2×2 window), and taking the largest element from the rectified feature map within that window. Similar to the convolution of convolution layer, a stride of 1, 2, or more may be taken to obtain the maximum value from the window. In some implementations, a 2×2 window for max pooling may be applied. However, it is recognized that other window sizes may be selected for max pooling. In addition, in some implementations, other types of spatial pooling may be used, e.g., average pooling, mean pooling, sum pooling (sum of inputs). The pooling layer may thereby generate another convolutional representation, e.g., a downsampled output array of pixel values containing, e.g., maximum values from the window applied across the input rectified feature map.

One or more of these additional layers may collectively result in downsampling 416 of the image; e.g., the resolution of the input image 310 may be lowered. From here, generator G 410 may implement further layers, e.g., another convolutional layer 418 and another set of layers for downsampling 420. Collectively, the foregoing layers (412-420) may be considered encoding layers for the input image 310. The result of the encoding layers may be input for decoding layers, where decoding layers are configured to generate a deconvolutional representation.

At the bottleneck 422, in some implementations, a skip connection 424 between the final encoding layer and the first decoder layer may be used to pass information to the next set of layers, the decoding layers. In some implementations, the information passed via the skip connection 424 may include original values that have been pooled (e.g., values that were max pooled in a pooling layer). The information may further include other pixel information, transform information (e.g., an indication that max pooling function was used by the pooling layer), and/or feature map information. In some implementations, the filter window for deconvolution may have defined dimensions, e.g., 3×3. In some implementations, further convolutional layers may be implemented instead of the skip layer 424.

In some embodiments, generator G 410 may include an upsampling layer 426. In some implementations, the upsampling layer 426 may be configured to upsample the input (e.g., an image represented by pixel values). In some implementations, upsampling may be accomplished via an interpolation filter that is configured to perform, e.g., bilinear interpolation.

Generator G 410 may further include a deconvolutional layer 428. In some implementations, the filter window for deconvolutional may have defined dimensions, e.g., 3×3. In FIG. 4, deconvolutional layer 428 may be a 3×3 deconvolutional layer, although other filter or kernel sizes may be used. Deconvolutional layer 428 may be configured to use information passed from the final set of layers of the encoder portion via the skip connection 424. In some implementations, the decoder portion may include a normalization layer and an activation layer (e.g., ReLU activation layer), which may perform substantially similar functions as those described above.

Generator G 410 may implement further layers, e.g., upsampling layer 430, deconvolutional layer 432 (3×3, corresponding to convolutional layer 414), and deconvolutional layer 434 (7×7, corresponding to convolutional layer 412). The resulting predicted image 320 (e.g., fake H&E image) may now have the same resolution as the input image (e.g., real PA histology image 310). In some instances, the resulting predicted image may be a recovered H&E image 360 based on a fake UV-PAM image 350 generated by generator F 450.

As alluded to above, the predicted image 320 will be in a second domain (e.g., having a visual characteristic of an H&E image), whereas the input image 310 is in a first domain (e.g., having a visual characteristic of a UV-PAM image). For example, as an imaging modality based on the photoacoustic effect, a UV-PAM image may have a color scheme that is different from an H&E image (e.g., black and white versus pink or purple coloration). H&E images may provide important information about the pattern, shape, and structure of cells in a tissue sample. An object of predicting an H&E image based on the UV-PAM image is to greatly reduce staining time associated with traditional H&E imaging.

In some embodiments, the predicted image 320 may be passed to a machine learning model such as discriminator D_{HE} 440, which may determine whether the predicted image 320 is a real H&E image or not (created by a generator). In some implementations, discriminator D_{HE} 440 may include convolutional layers 442 and downsampling layers 444 until an output is obtained. In some cases, the convolutional layers 442 may be 4×4 convolutional layers, similar to the type described above. It is recognized that other kernel sizes may be used for the convolutional layers. In some implementations, normalization (e.g., instance normalization), activation (e.g., using ReLU activation layers and leaky ReLU activation layers) may be used after each convolutional layer. Discriminator D_{HE} 440 may also include downsampling layers 444, which may include component layers such as a normalization layer, an activation layer, and/or a pooling layer, as described above.

Discriminator D_{HE} 440 may generate an output 446. In some implementations, the output 446 is a value representative of a metric indicative of a likelihood of the predicted image 320 being based on an H&E staining technique or not (e.g., based on UV-PAM). For example, the discriminator D_{HE} 440 may classify the predicted image 320 as a real H&E image or a fake H&E image (e.g., a UV-PAM image), which may be represented with said metric. As an example, a metric value of 1 generated by D_{HE} 440 may represent a real H&E image, and a value of 0 may represent a UV-PAM image, and values between 1 and 0 may represent a likelihood of a predicted image being a real H&E image (closer to 1 representing a higher likelihood of being a real H&E image) or a fake H&E image (closer to 0 representing a higher likelihood of being not a real H&E image). Similarly, a metric value of 1 generated by discriminator D_{PA} 480 may represent a real UV-PAM image, a metric value of 0 may represent a fake UV-PAM image, and values between 1 and 0 may represent a likelihood of a predicted image being a real UV-PAM image or a fake UV-PAM image. A midpoint value such as 0.5 may represent a determination by a discriminator that the image could be real or fake.

Initially, the discriminator D_{HE} 440 may produce values of over or under 0.5, meaning that the discriminator D_{HE} 440 is able to differentiate between real and fake H&E images. However, through iterative training and correction of parameters (e.g., weights) of discriminator D_{HE} 440 (e.g., by minimization of an error (e.g., a loss function) between real H&E images and generated H&E images, the minimization based on an optimization algorithm or process such as gradient descent), the metric may improve as the discriminator D_{HE} 440 is unable to determine the likelihood of the image being based on H&E image (a real H&E image) or based on another technique (e.g., UV-PAM), producing an output of closer to 0.5, which signifies that that the predicted image 320 may be a real or fake H&M image. The result of training generator G 410 may be the generator G 410 to be able to produce images that are unable to be determined (e.g., by a corresponding discriminator, e.g., D_{HE} 440) to be a real or fake H&E image. Hence, in the context of the present disclosure, it is desirable that an optimized generator of a GAN is capable of producing an image that an optimized discriminator is unable to “discriminate” or otherwise determine whether the image is real or fake. Gradient descent inherently involves adjusting one or more parameters of the cost function for each of the generator and discriminator models, which informs respective parameters (e.g., weights) of the model associated with the cost function. Minimizing the loss function means that the error is the smallest between the two images evaluated.

Second generator and discriminator: Similar to the first generator above (generator G 410), an input image may be provided to a second machine learning model (e.g., generator F 450). The input image may be from a second domain, e.g., a real H&E image 340 obtained using H&E staining, or a “fake” H&E image 320 or 360 with an appearance or characteristic of a real H&E stained image generated by, for example, generator G 410. In some cases, the input image may have a defined image patch size, such as 70×70, 512×512, or 1024×1024 pixels.

In some embodiments, the same encoding and decoding layers as those used in generator G 410 and discriminator D_{PA} 480 may be used to generate a UV-PAM image and evaluate the generated UV-PAM image. Generator F 450 may include convolutional layers 412, 414, 418, 428, 432, 434, 442, downsampling layers 416, 444, a skip connection 424, and upsampling layers 426, 430, each configured to perform substantially similar tasks as generator G 410 and discriminator D_{HE} 440 as described above. The resulting predicted image 350 (e.g., fake UV-PAM image) may now have the same resolution as the input image (e.g., real H&E image 340). In some instances, the resulting predicted image may be a recovered UV-PAM image 330 based on a fake H&E image 320 generated by generator G 410.

Hence, generator F 450 may generate or predict an output image in the first domain (e.g., predicted PA histology image 330), and discriminator D_{PA} 480 may generate an output 482, representing a metric indicative of a likelihood of the predicted image 330 being an H&E staining technique or a UV-PAM image. Similar to discriminator D_{HE} 440, through iterative training and correction of parameters (e.g., weights) of discriminator D_{PA} 480 (e.g., by minimization of an error (e.g., a loss function) between real UV-PAM images and generated UV-PAM images, the minimization based on an optimization algorithm or process such as gradient descent), the metric may improve and be able to determine that there is a higher likelihood that the predicted image 330 is a real UV-PAM image or a fake UV-PAM image (e.g., an H&E image), with the goal of generator F 450 being able to produce images that are unable to be discerned (e.g., by a corresponding discriminator, e.g., D_{PA} 480) whether the an image is a real or fake UV-PAM image. Hence, in the context of the present disclosure, it is desirable that an optimized generator of a GAN is capable of producing an image that an optimized discriminator is unable to “discriminate” or otherwise determine whether the image is real or fake. Gradient descent inherently involves adjusting one or more parameters of the cost function for each of the generator and discriminator models, which informs respective parameters (e.g., weights) of the model associated with the cost function. Minimizing the loss function means that the error is the smallest between the two images evaluated.

As mentioned above, each generator and discriminator may be configured to be updated based on an error. In some embodiments, the error may be a difference between the original input image to a first machine learning model and the output image of the other machine learning model. In some cases, the original input image may be the input to G (e.g., real UV-PAM image 310), and the output image may be the output of F (e.g., fake UV-PAM image 330). In some embodiments, the error may be pixel by pixel. Each pixel of the input image and the corresponding pixel of the output image (which has the same resolution) may have a difference in pixel value. The greater the difference in pixel value, the greater the error. In some embodiments, the mean-squared error may be used to determine a collective error of all the pixels. Other aspect of the images other than pixel values may also be evaluated for error-amount of red (R) when evaluating H&E images, amount of black when evaluating UV-PAM images, intensity value, saturation, etc. The input and output images may also be compared in terms of other units rather than pixels, e.g., macroblocks.

In some embodiments, an optimization such as gradient descent may be performed so as to allow update of parameters of the generators and discriminators. Through multiple iterations, the discriminators may achieve greater accuracy when determining whether the predicted image is from a first domain (e.g., PA) or a second domain (e.g., H&E), and thereby enable the generators to achieve greater accuracy when producing images of the second domain based on the first domain. The foregoing describes a forward-cycle consistency loss minimization. In the reverse, predicting an image in the first domain based on an image in the second domain, a backward-cycle consistency loss minimization may be accomplished.

To sum, to determine forward-cycle consistency loss, input an image of first domain to a first generator/GAN (G), output a predicted image of second domain from the first generator/GAN, input the predicted image of second domain to a second generator/GAN (F), output a predicted image of first domain from the second generator/GAN (F), and compare the input image of first domain with the predicted image of first domain to find an optimal set of parameters.

To determine a backward-cycle consistency loss, input an image of second domain to a first generator/GAN (F), output a predicted image of first domain from the first generator/GAN (F), input the predicted of first domain to a second generator/GAN (G), output a predicted image of second domain from the second generator/GAN (G), and compare the input image of second domain with the predicted image of second domain to find an optimal set of parameters.

### IV. Methods for Virtually Staining Histology Images

FIG. 5 is a flow diagram illustrating a method of training a first machine learning model to virtually stain one or more histology images, according to some embodiments. One or more of the functions of the method 500 may be performed by or caused by a computerized apparatus or system. Means for performing the functionality illustrated in one or more of the steps shown in FIG. 5 may include hardware and/or software components of such computerized apparatus or system, such as, for example, a controller apparatus (e.g., a computing device and/or controller 170 and/or its components), a computerized system, or a computer-readable apparatus including a storage medium storing computer-readable and/or computer-executable instructions that are configured to, when executed by a processor apparatus, cause the at least one processor apparatus or a computerized apparatus to perform the operations. Example components of a computerized apparatus are illustrated in FIG. 1, and described in more detail elsewhere herein.

It should also be noted that the operations of the method 500 may be performed in any suitable order, not necessarily the order depicted in FIG. 5. Further, the method 500 may include additional or fewer operations than those depicted in FIG. 5 to train the model.

At block 510, the method 500 may include inputting a first histology image obtained using a first histological technique to the first machine learning model to generate a first predicted image having a characteristic of a second histological technique. In some embodiments, the first histological technique may include photoacoustic (PA) imaging, e.g., using a UV-PAM system such as that described with respect to FIG. 1 or FIG. 2. The first histology image may be a UV-PAM image obtained using the first histological technique. In some embodiments, the first machine learning model may be a generator (e.g., generator G 410 or generator F 450). A discriminator corresponding to the generator may also be implemented, as was discussed above and will be further discussed below. The second histological technique may include hematoxylin and eosin (H&E) staining, and the first predicted image may be a predicted H&E image generated by the first machine learning model.

Characteristics of a UV-PAM image and an H&E image differ. For example, a UV-PAM image may be grayscale, while an H&E image has color in shades of pink (e.g., varying amounts of red per pixel). As discussed above, such UV-PAM image may be virtually stained to produce an image that resembles an H&E-stained image. Hence, in some implementations, the characteristic of the second histological technique may include an amount of red in each pixel (for H&E images). In some implementations, other image parameters may be considered as the characteristic, e.g., intensity value or saturation.

UV-PAM and H&E may also be considered first and second domains, between which a pair of trained generators may produce images of one domain from another domain, e.g., from an image of the first domain (e.g., UV-PAM image or predicted UV-PAM, or H&E image or predicted H&E image) to an image of the second domain (e.g., virtually stained and predicted H&E image, or predicted UV-PAM image).

At block 520, the method 500 may include inputting the first predicted image to a second machine learning model configured to generate a second predicted image having a characteristic of the first histological technique. In some embodiments, the second machine learning model may be another generator (e.g., generator F 450), and the second predicted image may be a predicted UV-PAM image generated by the second machine learning model. In some implementations, the characteristic of the second histological technique may include an amount of black in each pixel (for UV-PAM images). In some implementations, other image parameters may be considered as the characteristic, e.g., intensity value or saturation. Since the

At block 530, the method 500 may include, based on an error associated with the first histology image and the second predicted image, updating one or both of the first machine learning model or the second machine learning model. In some embodiments, the error may be determined between the first histology image and the second predicted image, where the first histology image is the input UV-PAM image, and the second predicted image is the predicted UV-PAM image generated by the second machine learning model. In some implementations, the error may be determined on a pixel-by-pixel basis, where the difference between each pixel of the first histology image and the corresponding pixel of the second predicted image is determined. For example, the pixel value and/or another characteristic of the pixel (e.g., amount of color) may be evaluated (e.g., compared) between the two images. Since a generator produces an image having the same resolution via the process of downsampling and upsampling to recover the same resolution (see, e.g., the layers described with respect to FIG. 4), the two images have the same resolution. In some embodiments, a loss function based on a mean-squared error of all the pixel errors may be determined, which may then be minimized using an optimization process such as gradient descent.

Gradient descent inherently involves adjusting one or more parameters of the cost function, which informs the parameters (e.g., weights) of the model associated with the cost function. Minimizing the loss function means that the error is the smallest between the two images evaluated. In some embodiments, the updating of the first machine learning model or the second machine learning model includes updating one or more parameters (e.g., weights), e.g., using backpropagation. A machine learning model such as a generator may thus be trained using the above process.

Similarly, machine learning model such as a discriminator may also be trained by minimizing an error (e.g., a loss function) between the input image that is a generated image (e.g., the first predicted image generated by the first machine learning model, resembling an H&E image) and a reference image (e.g., a real H&E image) using an optimization algorithm or process such as gradient descent. By adjusting the parameters of the loss function for the discriminator, the error can be gradually minimized, and be able to generate an output (e.g., 446, 482) that is closer to either 0 or 1, where 0 corresponds to an image in the first domain and 1 corresponds to an image in the second domain. In other words, training the discriminator means updating its weights such that its predicted output will approach 0.5, where 0.5 indicates that the discriminator cannot differentiate between real and fake images (e.g., real vs. fake UV-PAM images, or real vs. fake H&E images), and moving close to 0 or 1 indicates that the discriminator can determine whether an image is real or fake. In some embodiments, the goal of training the generator is to create images (e.g., virtually stained H&E images) that are unable to be discerned as real or fake.

In some embodiments, the method 500 may further include inputting the first predicted image to a third machine learning model (e.g., a first discriminator, e.g., D_{HE} 440) corresponding to the first machine learning model, the third machine learning model configured to determine a first metric indicative of a likelihood of the first predicted image having been obtained using the second histological technique. The second histological technique may be H&E staining, as noted above. The first discriminator may then be trained according to the above. Similarly, the method 500 may further include inputting the second predicted image to a fourth machine learning model (e.g., a second discriminator, e.g., D_{PA} 480) corresponding to the third machine learning model, the fourth machine learning model configured to determine a second metric indicative of a likelihood of the second predicted image having been obtained using the first histological technique. The first histological technique may be PA imaging, as noted above.

It will be appreciated that, in other embodiments, the first histological technique may be H&E staining and the second histological technique may be PA imaging. That is, method 500 may apply for, e.g., recovering or generating a UV-PAM image (e.g., 330, 350) from an H&E image (virtual or real).

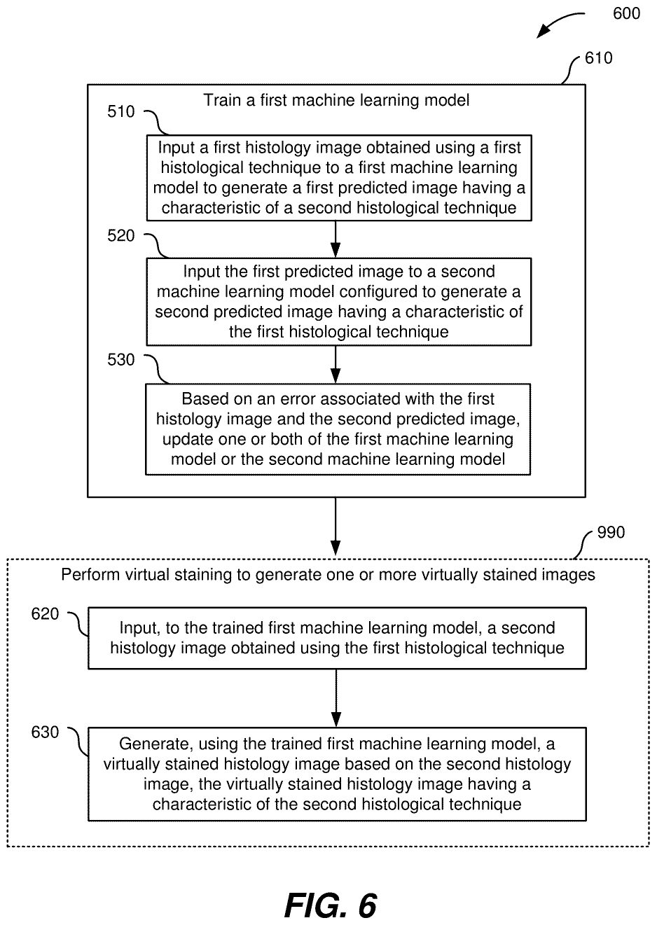

FIG. 6 is a flow diagram illustrating a method of virtually staining one or more histology images, according to some embodiments. One or more of the functions of the method 600 may be performed by or caused by a computerized apparatus or system. Means for performing the functionality illustrated in one or more of the steps shown in FIG. 6 may include hardware and/or software components of such computerized apparatus or system, such as, for example, a controller apparatus (e.g., a computing device and/or controller 170 and/or its components), a computerized system, or a computer-readable apparatus including a storage medium storing computer-readable and/or computer-executable instructions that are configured to, when executed by a processor apparatus, cause the at least one processor apparatus or a computerized apparatus to perform the operations. Example components of a computerized apparatus are illustrated in FIG. 1, and described in more detail elsewhere herein.

It should also be noted that the operations of the method 600 may be performed in any suitable order, not necessarily the order depicted in FIG. 6. Further, the method 600 may include additional or fewer operations than those depicted in FIG. 6 to virtually stain a histology image.

At block 610, the method 600 may include training a first machine learning model. In some embodiments, the first machine learning model may be a generator, such as generator G 410 or generator F 450 as discussed with respect to FIG. 4 above. In some embodiments, the training may include blocks 510, 520 and 530 as discussed with respect to FIG. 5 above. Training the first machine learning model may generate a trained first machine learning model (e.g., a trained generator).

At block 620, the method 600 may include inputting, to the trained first machine learning model, a second histology image obtained using the first histological technique. As an example, the first histology image obtained using a first histological technique (block 510) may be a first UV-PAM image, and the second histology image obtained using the first histological technique may be a second UV-PAM image.

At block 630, the method 600 may include generating, using the trained first machine learning model, a virtually stained histology image based on the second histology image (obtained using the first histological technique), the virtually stained histology image having a characteristic of the second histological technique. In some embodiments, virtually stained histology image is an H&E image generated using the trained generator, while the second histology image is a UV-PAM image. In some implementations, the characteristic of the second histological technique may include an amount of red in each pixel. In other implementations, the characteristic may include intensity value, saturation, or other image parameters.

Hence, the trained first machine learning model (e.g., a generator) may receive another image of the same domain as image(s) the generator was trained on (e.g., UV-PAM), and predict an image of another domain (e.g., H&E).

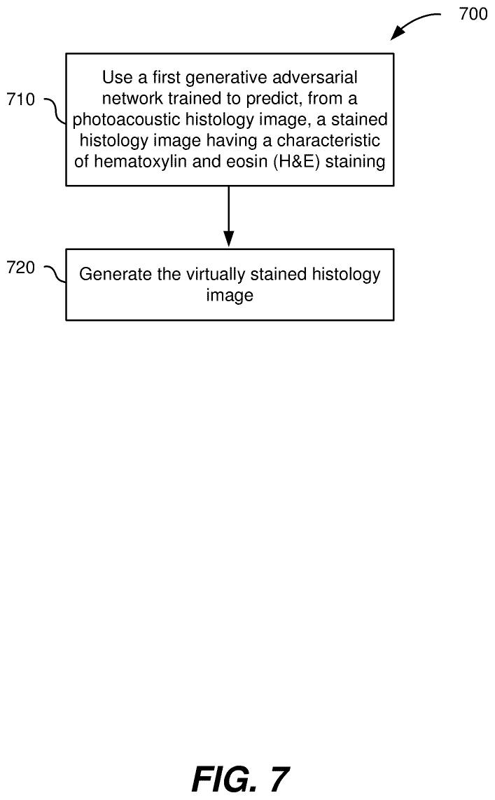

FIG. 7 is a flow diagram illustrating a method of virtually staining one or more histology images, according to some embodiments. One or more of the functions of the method 700 may be performed by or caused by a computerized apparatus or system. Means for performing the functionality illustrated in one or more of the steps shown in FIG. 7 may include hardware and/or software components of such computerized apparatus or system, such as, for example, a controller apparatus (e.g., a computing device and/or controller 170 and/or its components), a computerized system, or a computer-readable apparatus including a storage medium storing computer-readable and/or computer-executable instructions that are configured to, when executed by a processor apparatus, cause the at least one processor apparatus or a computerized apparatus to perform the operations. Example components of a computerized apparatus are illustrated in FIG. 1, and described in more detail elsewhere herein.

It should also be noted that the operations of the method 700 may be performed in any suitable order, not necessarily the order depicted in FIG. 7. Further, the method 700 may include additional or fewer operations than those depicted in FIG. 7 to virtually stain a histology image.

At block 710, the method 700 may include using a first generative adversarial network trained to predict, from a photoacoustic histology image, a stained histology image having a characteristic of hematoxylin and eosin (H&E) staining. In some embodiments, the photoacoustic histology image may be a UV-PAM image. The first generative adversarial network may include a trained generator and a trained discriminator. In some embodiments, the generator has been trained in conjunction with a corresponding trained discriminator and a second generative adversarial network that includes a generator and a corresponding discriminator (which in some scenarios may also be trained). The training of the generator of the first generative adversarial network may be accomplished using the methodology 500 of FIG. 5 (e.g., blocks 510, 520, 530).

At block 720, the method 700 may include generating the virtually stained histology image. In some embodiments, the virtually stained histology image may have the characteristic of H&E staining, e.g., amount of red in each pixel, intensity value, saturation, or other image parameters.

By using a trained generator to generate a virtually stained H&E image from a UV-PAM image which cannot be distinguished from a real H&E image, significant amounts of time and resources may advantageously be saved over conventional methods such as manual H&E staining.

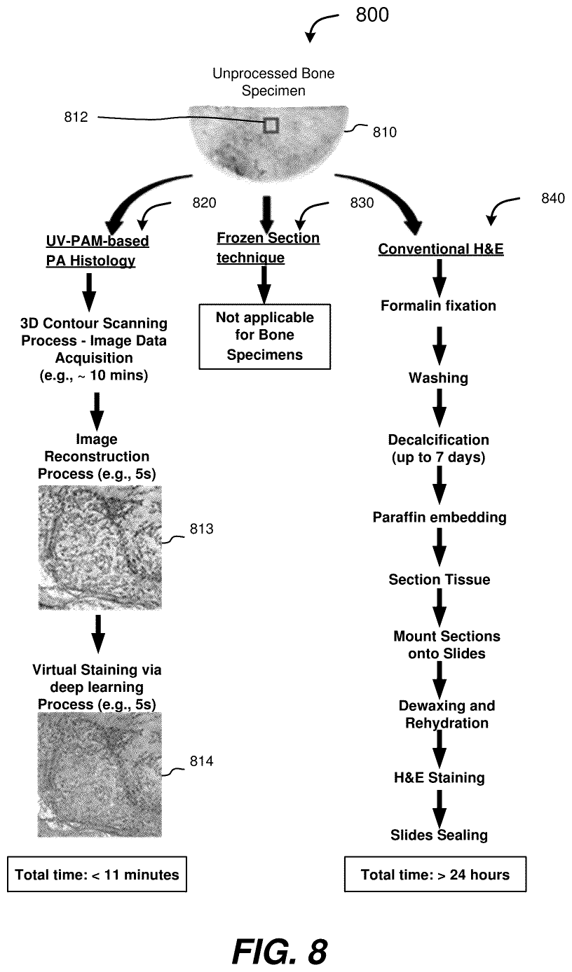

Certain embodiments pertain to UV-PAM techniques that employ 3D contour-scanning and deep learning-based virtual staining. With the 3D contour-scanning UV-PAM system employing deep learning assisted virtual staining, there is a possibility of intraoperative diagnosis of unprocessed tissue (e.g., bone). FIG. 8 is a schematic diagram depicting workflows of both an example of UV-PAM photoacoustic histology 820 and a traditional H&E staining histology 840 of bone specimens for comparison. Unlike soft biological tissues, hard bone samples cannot be processed by the widely used frozen section technique 830 for intraoperative examination. The traditional H&E histology techniques 840 for bone involve multiple complicated and time-consuming procedures, such as bone decalcification. It can take up to 7 days for some bone specimens to be fully decalcified before sectioning and H&E staining. In contrast, the UV-PAM based histology technique 820 of one example may be able to produce virtually stained images of unprocessed bone for intraoperative examination within about 11 minutes for a 0.625 μm step size with 1×1 mm² field-of-view (FOV). It may take less than 5 seconds for virtual staining with the trained convolutional neural network (CNN). An example of a grayscale image 813 and an example of a virtually stained image 814 of a portion 812 of an unprocessed bone specimen 810 are shown.

### V. UV-PAM Imaging Methods

According to certain embodiments, UV-PAM imaging methods may image a rough surface of unprocessed thick samples like bone tissue specimens by employing a real-time 3D contoured scanning process that does not require previous knowledge of the sample surface. The 3D contoured scanning process uses a 3D contoured scanner (e.g., including a 3-axis motorized stage) that may be configured to maintain consistent lateral resolution within the field-of-view being imaged. In some cases, the distance between the specimen and the optical focus is kept within the depth-of-field (DOF) during scanning for consistent and optimal optical resolution.

In the 3D contoured scanning process of certain implementations, the time-of-flight information of photoacoustic signals may be used to calculate the distance between the specimen and the focal spot of the ultrasonic transducer device, which can be used to adjust the trajectory of the 3D contoured scanner for 3D contoured scanning with z-position compensation. For example, a profile surface curve of the sample surface may be determined from the time-of-flight information. The compensation steps used to determine the trajectory of the 3D contoured scanner can be calculated based on a difference between the focal length of the ultrasonic transducer device and the distance between the ultrasonic transducer device and the profile surface curve.

Prior to UV-PAM imaging, the optical and acoustic foci may be confocally aligned (e.g., in a calibration process), while the propagation time of the acoustic signal from the optical focus is recorded to determine the focal spot position. To extract the ultrasound propagation time (time of flight), the center of positive and negative peak positions in photoacoustic A-line signals may be calculated, which is converted to the sample position to determine the time of flight at each scanning position.

Without needing prior knowledge of the sample surface profile, a seed two-dimensional (2D) scan (e.g., seed B-scan) may be performed without axial movement (e.g., z-movement by the z-motor of a 3D contoured scanner being disabled or not used) to determine the starting contour trajectory for the subsequent first 2D contoured scan. The first 2D contoured scan is then performed using the starting contour trajectory. One or more additional 2D contoured scans are then performed. After each 2D contoured scan, the distances between the sample surface and the ultrasonic transducer device are calculated using the time-of-flight data. These distances are used to compute a surface profile and a contour trajectory for the subsequent contoured scan. Due to a small step (e.g., y step of 0.625 μm) between adjacent 2D contoured scans, each contour trajectory (e.g., z-motor trajectory) is set to follow the surface profile from the previous 2D contoured scan. This process is repeated to acquire additional 2D contoured scans until scanning of the field-of-view is complete. Real-time data processing and system control may be implemented using MATLAB and Lab VIEW hybrid programming or the like.

In some cases, to avoid potential noise interference and remove outliers, at least a 100-point moving average may be used in each 2D scan to generate a smooth scanning trajectory. During each 2D contoured scan, the 3D contoured scanner moves in both directions simultaneously along the plane. For example, if the 3D contoured scanner includes a 3-axis motorized stage with an x-axis motor, a y-axis motor, and a z-axis motor, the x-axis motor and the z-axis motor move simultaneously during each 2D contoured scan.

In certain implementations, a 3D contoured scanning photoacoustic method includes real-time three-dimensional contoured photoacoustic scanning of a surface of a specimen using time-of-flight data from one or more photoacoustic signals detected by an ultrasonic transducer device. In some cases, a plurality of 2D photoacoustic scans are performed of the specimen. These 2D photoacoustic scans include at least one seed 2D photoacoustic scan and one or more 2D contour photoacoustic scans. Each contour 2D photoacoustic scan is performed using axial (e.g., z-direction) compensation steps calculated using time-of-flight data of one or more photoacoustic signals detected during a previous adjacent 2D photoacoustic scan of the plurality of 2D photoacoustic scans. For example, a first contour 2D photoacoustic scan may be performed using axial compensation steps calculated using time-of-flight data of one or more photoacoustic signals detected during a seed 2D photoacoustic scan where the seed 2D photoacoustic scan is performed prior to the first contour 2D photoacoustic scan in the previous step (e.g., y-position) scanned. As another example, a second contour 2D photoacoustic scan may be performed using axial compensation steps calculated using time-of-flight data of one or more photoacoustic signals detected during a first contour 2D photoacoustic scan where the first contour 2D photoacoustic scan is performed prior to the second contour 2D photoacoustic scan in the previous step (e.g., y-position) scanned.

FIG. 9 is a flowchart 900 illustrating an example of a UV-PAM method, according to various embodiments. The operations shown in flowchart 900 are for illustration purposes only and are not intended to be limiting. In various implementations, modifications may be made to flowchart 900 to add or omit one or more operations or change the order of operations. The operations in flowchart 900 may be performed using a UV-PAM system such as, for example, UV-PAM system 100 shown in FIG. 1 or UV-PAM system 200 shown in FIG. 2. The two-dimensional (2D) scans (e.g., B-scans) in the UV-PAM method may be performed in reflection mode such as shown in FIG. 2 where the ultrasonic transducer device 240 is located to the same side of the specimen as the direction from which the one more ultraviolet pulses are delivered. In reflection mode, the one or more ultraviolet pulses are provided to the surface of the specimen and photoacoustic signals induced by the one or more ultraviolet pulses at the surface, or near the surface, of the specimen are reflected back from the specimen surface.

Without prior knowledge of the sample surface profile, a seed 2D scan may be performed to calculate the starting contour trajectory for the subsequent first contoured scan. At operation 910, a pre-imaging (seed) two-dimensional scan (e.g., B-scan) is performed at an initial plane (e.g., x-z plane shown in FIG. 9). The pre-imaging 2D scan employs a 3D contoured scanner (e.g., 3D contoured scanner 180 and 3D contoured scanner 280) to scan the specimen in one direction (e.g., along the x-axis shown in FIG. 9) while an ultrasonic transducer device (e.g., ultrasonic transducer device 140 in FIG. 1 or ultrasonic transducer device 240 in FIG. 2) detects one or more photoacoustic signals from the specimen induced by one or more ultraviolet pulses from, for example, a UV laser (e.g. UV laser 110 in FIG. 1 or UV laser 210 in FIG. 2). In addition or alternatively, the ultrasonic transducer device can be moved relative to the specimen. One or more DAQs (e.g., DAQ(s) 160 in FIG. 1 or DAQ(s) 260 in FIG. 2) digitize and record the one or more photoacoustic signals amplified by one or more pre-amplifiers (e.g., pre-amplifier(s) 150 in FIG. 1 or pre-amplifier(s) 250 in FIG. 2).

At operation 920, a surface (profile) curve of the specimen is extracted using time-of-flight data from the photoacoustic signals detected during the pre-imaging 2D scan. FIG. 9 includes an illustration of an example of an image of a pre-imaging 2D scan 921 and a surface curve 922 extracted from time-of-flight data of the photoacoustic signals detecting during the pre-imaging 2D scan 921. The scale bar is 500 μm. The time-of-flight can refer to the time between the photoacoustic signal being generated at the surface of the specimen and the time the ultrasonic transducer device receives the photoacoustic signals. The distance between the specimen surface and the ultrasonic transducer device can be calculated at each scanning position (e.g., x scanning position) of the pre-imaging 2D scan to determine the surface (profile) curve.

At operation 930, a plurality of contour compensation steps (e.g., z-motor steps) are calculated for the first contoured scan. The contour compensation steps are calculated to position the specimen surface at, or approximately at, the focal plane of the ultrasonic transducer device during the subsequent 2D contoured scan. Each contour compensation step is calculated as the difference between the focal length and the distance between the specimen surface, defined by the extracted surface curve, and the ultrasonic transducer device at each scanning position.

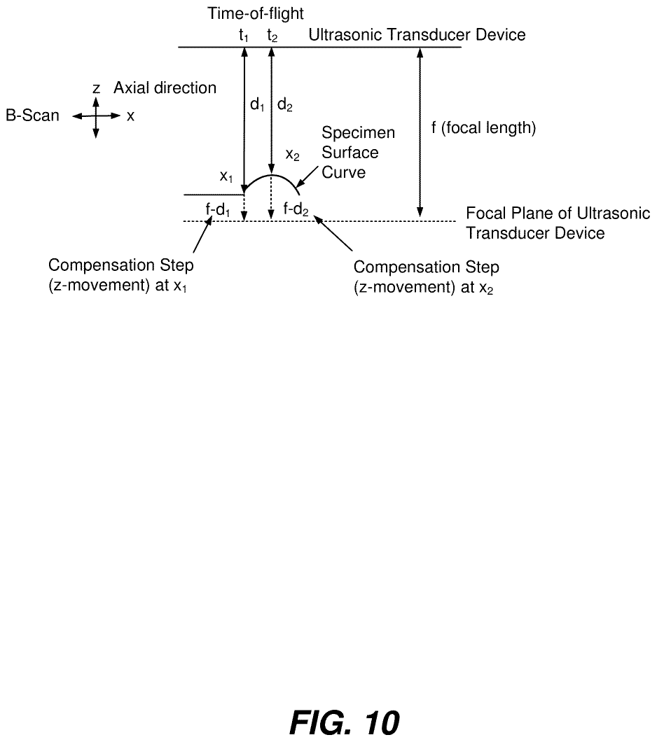

FIG. 10 is a schematic illustration of time-of-flight, t₁ and t₂, at two respective scanning positions, x₁ and x₂. In this example, the time-of-flight can refer to the time between the photoacoustic signal generated at the surface of the specimen and the time the ultrasonic transducer device receives the photoacoustic signals. The distance between the specimen surface and the ultrasonic transducer device can be calculated at each scanning position (e.g., x scanning position) to determine the surface (profile) curve. For example, as shown in FIG. 10, the distances, d₁ and d₂, between the specimen surface and the ultrasonic transducer device can be calculated at respective scanning positions, x₁ and x₂, using respective time-of-flight, t₁ and t₂, and the speed of the photoacoustic wave. The contour compensation steps is the difference between the focal length, f, and the distances, d₁ and d₂, between the specimen surface and the ultrasonic transducer device: f−d₁ and f−d₂.

At operation 940, the first contoured scan is performed with contour compensation based on the calculated contour compensation steps. The 3D contoured scanner scans the specimen along a trajectory according to the calculated contour compensation steps and the scanning positions. The 3D contoured scanner scans along two directions simultaneously (e.g., a lateral direction such as the x-direction along x-axis and in an axial direction such as the z-direction along the z-axis shown in FIG. 9) along the trajectory while an ultrasonic transducer device detects photoacoustic signals along the plane (e.g., x-z plane) from the specimen induced by one or more ultraviolet pulses from the UV laser. In addition or alternatively, the ultrasonic transducer device can be moved relative to the specimen.

At operation 950, a surface curve of the specimen is extracted using time-of-flight data from the photoacoustic signals detected during the first 2D contoured scan and updated contour compensation steps (e.g., z-motor steps) are calculated for the subsequent contoured scan using the extracted surface curve.

At operation 960, the 3D contoured scanner is incremented by a step and an additional contoured scan is performed with contour compensation based on the updated contour compensation steps. Due to step size between adjacent 2D contoured scans typically being small (e.g., y step of, for example, 0.625 μm), each contour trajectory (e.g., z-motor trajectory) is set to follow the surface profile from the previous 2D contoured scan.

At operation 970, it is determined whether all the planes of the specimen have been scanned in the field-of-view. If all the planes have not been scanned in the field-of-view being imaged, the method returns to operation 960.

If all the planes have been scanned in the field-of-view, the method extracts a surface curve for the current contoured scan and performs an image reconstruction process to form one or more grayscale UV-PAM images (operation 980). To reconstruct the UV-PAM grayscale images, the photoacoustic amplitude of each A-line signal (signal at each scanning position) of each two-dimensional contoured scan may be calculated after the Hilbert transform. The pulse energy measurements taken by a photodiode (e.g., photodiode 130 in FIG. 1 or photodiode 230 in FIG. 2) may be used to normalize the photoacoustic amplitude and compensate for laser pulse fluctuation in the UV laser pulses from the UV laser (e.g., UV laser 110 in FIG. 1 or UV laser 210 in FIG. 2). The axial position (e.g. z-position in scan 921 in FIG. 9) of the specimen surface is calculated by detecting the peak of the A-line signal after the Hilbert transform. Each UV-PAM grayscale image is a 2D MAP (maximum amplitude projection) image that is self-normalized. Since the photoacoustic amplitude of the contrast is proportional to its absorption cross-section, it may be used to effectively differentiate cell nuclei, cytoplasm, and the background. The cell nuclei have the largest absorption coefficient at 266 nm and the highest PA signals.

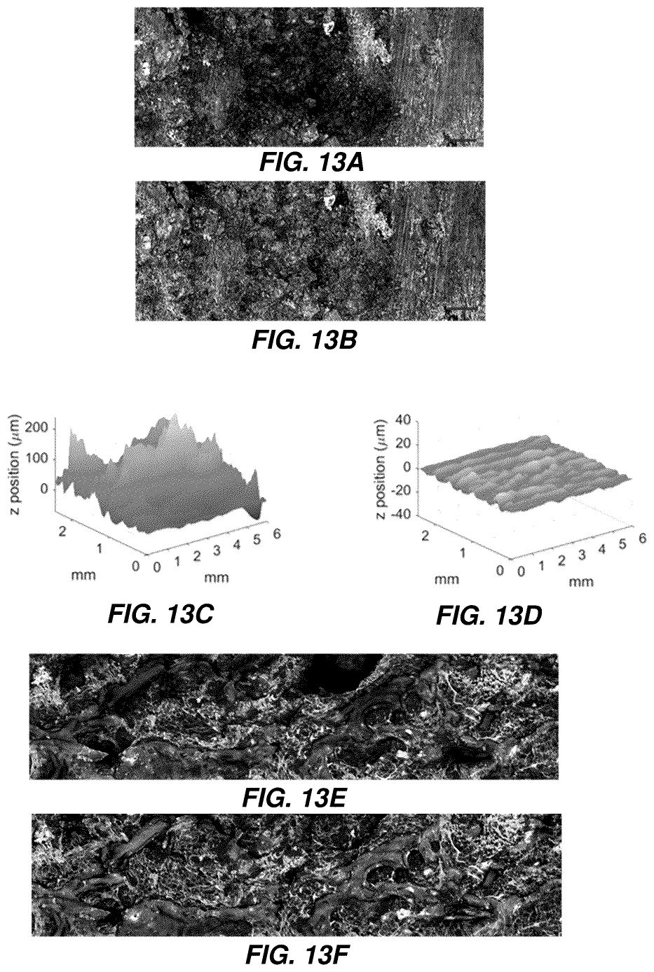

To reconstruct a UV-PAM image, the photoacoustic amplitude of each A-line signal (signal at each scanning position) of each two-dimensional contoured scan may be calculated after the Hilbert transform. The pulse energy measurements taken by the photodiode may be used to normalize the photoacoustic amplitude and compensate for laser pulse fluctuation in the UV laser pulses from UV laser. The axial position (e.g. z-position in scan 921 in FIG. 9) of the specimen surface is calculated by detecting the peak of the A-line signal after the Hilbert transform. Each UV-PAM grayscale image is a 2D MAP (maximum amplitude projection) image that is self-normalized. A 3D profile image (e.g., 3D profile image in FIG. 13D) may be generated using the calculated axial positions (e.g., z-axis positions) relative to the focal plane.

Optionally (denoted by dashed line), at operation 990, a trained neural network may be used in a deep learning virtual staining process to convert the one or more UV-PAM grayscale images into pseudocolor virtually stained histology images. Examples of deep learning virtual staining methods are described in Section IV.

### VI. Demonstrations of UV-PAM Systems and Methods

The UV-PAM systems described herein (e.g., UV-PAM system 100 illustrated in FIG. 1 and UV-PAM system 200 illustrated in FIG. 2) may be used in reflection mode to image unprocessed thick specimens with rough surfaces (e.g., bone specimens) for, e.g., intraoperative evaluation. UV-PAM system 200 in FIG. 2 was used to generate UV-PAM images of unprocessed thick bone specimens (>1 cm) with rough surfaces. The UV-PAM images of both undecalcified and decalcified bone specimens acquired by UV-PAM system 200 were acquired and compared with gold-standard hematoxylin and eosin (H&E) images. In addition, a UV-PAM method including an unsupervised deep learning virtual staining process based on cycle-consistent generative adversarial networks (CycleGANS) was used to convert grayscale UV-PAM images into pseudocolor H&E-like histology images, which provide the pathologist with complementary contrast and help interpret PAM images. The pseudocolor virtually stained images may also allow pathologists the possibility of identifying cancerous features according to existing pattern-recognition rules. The unsupervised deep learning virtual staining process based on cycle-consistent generative adversarial networks (CycleGANS) does not require coupled pairs of stained and unstained images, avoiding the need for well-aligned UV-PAM and H&E-stained images for neural network training, which can be challenging to acquire due to artifacts caused by sample preparation-induced morphology changes. Since the label-free (i.e., free of physical H&E staining) photoacoustic (PA) histology enabled by UV-PAM techniques avoid the need for certain tissue processing (e.g., decalcification and sectioning) and H&E staining, these techniques provide the possibility for rapid intraoperative diagnoses of unprocessed specimens, which may improve orthopedic oncology surgery.

### Unprocessed Bone Specimens

To demonstrate UV-PAM imaging of unprocessed thick bone specimens, mineralized primary bone samples were extracted from patients in tumor resection surgeries and immediately fixed in formalin solution after surgical excision to prevent degradation. No further cutting or sectioning was implemented with the bone specimen, avoiding the need for paraffin or agarose embedding. The bone specimens were placed onto water-immersed sample holder 282 in UV-PAM system 200 (shown in FIG. 2) for 3D contour scanning. The left tibia bone specimens were taken from a patient with osteofibrous dysplasia-like adamantinoma, which has a rough surface due to the surgical excision by an oscillating saw. The image acquired by 2D raster scanning without contour compensation (e.g., seed B-scan) shows a large portion of the out of-focus area within the FOV, resulting in an inconsistent resolution and poor image quality. The rough bone surface profile can be reconstructed by the time-of-flight information of photoacoustic signals, revealing a large fluctuation in surface height. In contrast, the UV-PAM image acquired by 3D contour scanning of the same area showed a significantly improved image quality and consistent resolution across the FOV. For the validation of bone photoacoustic histology, the UV-PAM images of decalcified bone specimens were compared with gold-standard H&E images by a traditional optical microscope. The decalcified bone specimen extracted from a patient with metastatic adenocarcinoma was imaged using the UV-PAM and compared with its corresponding H&E image. The UV-PAM image shows almost identical features to the H&E-stained image, in which abnormal tumor glands are readily observable. To match traditional histology images, virtual H&E staining was performed on the grayscale PAM images using a CycleGAN-based deep learning method.

The bone specimens used for UV-PAM imaging were procured from larger specimens in a pathology laboratory, surgically removed from patients. All bone specimens were fixed in 10% buffered formalin prior to any other procedures. For thick undecalcified specimens, the bone specimens were mounted to the sample holder 282 of UV-PAM 200 for imaging without further processing. To decalcify specimens, the bone specimens were treated with decalcifying solution containing chelating agents in dilute HCl, while the treatment time varied depending on the size and hardness of the specimens. After fixation and decalcification, the specimen was embedded in paraffin wax, sectioned into 5-micron thick slices, and placed on glass slides. Specimens with less calcification were sectioned without calcification. These slices were then processed with standard H&E staining and cover-slipped. The H&E-stained slides were imaged using either the standard optical microscope or the digital whole slide scanning using Leica Aperio AT2 with a 40× objective.

FIG. 13A is an image of the undecalcified left tibia bone specimen acquired by 2D raster scanning without contour compensation. FIG. 13B is an image of the undecalcified left tibia bone specimen acquired by 3D contour scanning by 3D contour-scanning UV-PAM 200. The axial direction relative to the optical focal plane for the contoured scanning profile are calculated by the time-of-flight information of the photoacoustic signal. In comparison with the image in FIG. 13A, the image in FIG. 13B shows an improved image quality by 3D contoured scanning of the undecalcified bone specimen with a rough surface. The image in FIG. 13A acquired by 2D raster scanning without contour compensation shows a large portion of the out-of-focus area within the FOV (2.5×6.25 mm2), resulting in less consistent resolution and lesser image quality. FIG. 13C is 3D plot of an example of a scanning profile acquired by 2D raster scanning. FIG. 13D is 3D plot of an example of a scanning profile acquired by 3D contour-scanning. The rough bone surface profile in FIG. 13C, shows a large fluctuation in surface height and less than 10% of the pixels within the DOF. In contrast, the UV-PAM image acquired by the 3D contour scanning of the same area showed significantly improved image quality and consistent resolution across the FOV with less fluctuation in surface height as shown in FIG. 13D. More than 92% of the surface area in FIG. 13D is within the small DOF during the 3D contour scanning. The specimen surface position in the axial direction relative to the optical focal plane is calculated by the time-of-flight information of the photoacoustic signal. Another comparison between the 2D raster-scanning image and 3D contour-scanning image of unprocessed patient bone can be found in FIGS. 13E and 13F. FIG. 13E is an image of the normal unprocessed thick bone sample acquired by 2D raster scanning without contour compensation. FIG. 13F is an image of normal unprocessed thick bone sample acquired by 3D contour scanning. As shown in FIG. 13F, important bone structures, such as trabeculae and marrow, can be visualized by UV-PAM with specimen integrity.

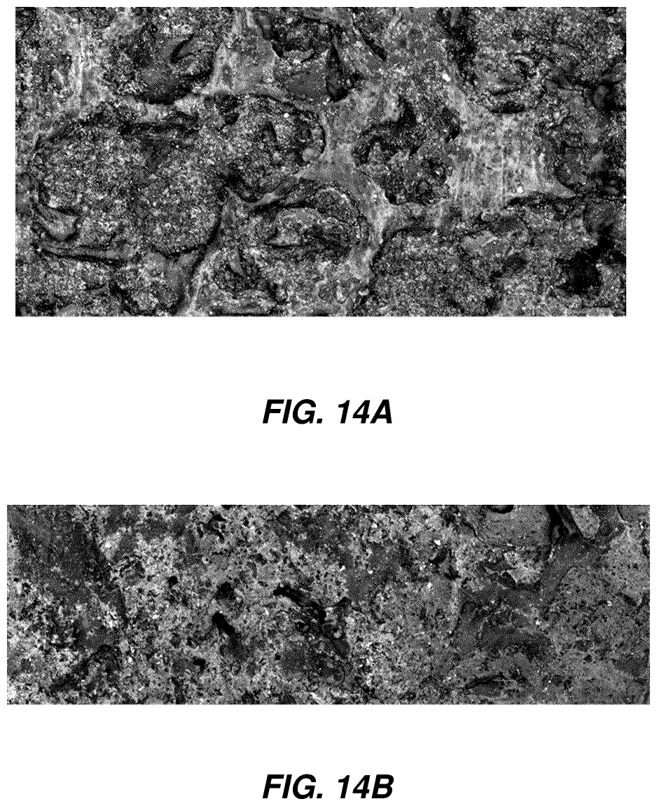

FIG. 14A is an image of the undecalcified thick bone specimen from a normal area acquired by 3D contour scanning using 3D contour-scanning UV-PAM 200. FIG. 14B is an image of the undecalcified thick bone specimen with an area with metastasized cancer acquired by 3D contour scanning using 3D contour-scanning UV-PAM 200.

By comparing the images of the rough surfaces of unprocessed thick bone specimens acquired by raster scanning with the images acquired by 3D contour scanning, the images with have higher quality. Since 3D contour scanning UV-PAM imaging is nondestructive, the unprocessed bone specimens may also be used for further pathological diagnosis.

### Label-Free UV-PAM of Decalcified and Undecalcified Bone Specimens

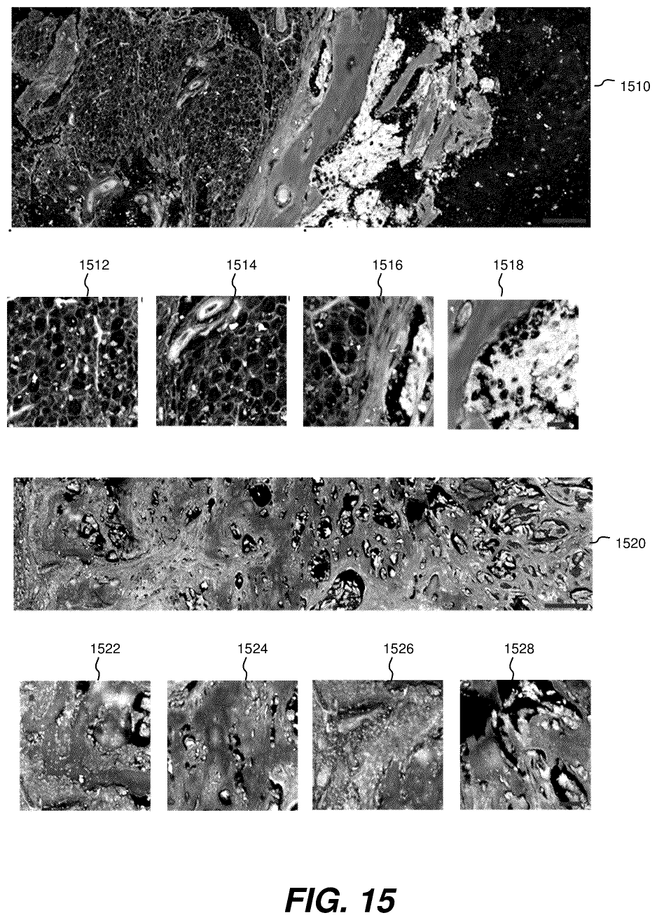

Since the traditional H&E image of bone usually requires decalcification and cutting into thin sections (e.g., 5-8 μm), 3D contour UV-PAM imaging of a formalin-fixed paraffin-embedded (FFPE) decalcified bone fragment without malignancy on a glass slide was acquired. FIG. 15 depicts example images of decalcified bone specimens acquired by 3D contour scanning using 3D contour-scanning UV-PAM system, according to some embodiments. The images include an image 1510 of the decalcified normal bone fragment without malignancy with scale bar of 500 μm, a closeup image 1512 of marrow cells, with the fatty color in black, a closeup image 1514 showing a vessel in the upper left-hand corner, a closeup image 1516, a closeup image 1518 showing osteoid in the left upper corner, an image 1520 of the FFPE decalcified bone specimen with metastatic poorly differentiated adenocarcinoma of pulmonary origin, a closeup image 1522, a closeup image 1524, a closeup image 1526, and a closeup image 1528. As shown in image 1510, obvious bone structures like mineralized bone can be readily visualized. Close-up images 1512, 1514, 1516, and 1518 reveal clear differentiation of cell nuclei and cytoplasm and the morphology of the bony structure. Close-up images 1522, 1524, 1526, and 1528 show well-differentiated cell nuclei.

The decalcified bone specimen from the patient with chondroblastic osteosarcoma is also imaged by UV-PAM and shown in FIG. 16. FIG. 16 depicts additional example images of decalcified bone specimens acquired by 3D contour scanning using 3D contour-scanning UV-PAM system, according to some embodiments. The images include an image 1610 of an undecalcified thick bone specimen with an area with metastasized cancer and close-up images 1612, 1614, and 1616 where the scale bar is 100 μm.

UV-PAM images of both decalcified and undecalcified bone specimens were compared with gold-standard H&E images acquired by a traditional optical microscope. The contrast of some of these UV-PAM images is reversed to highlight the high absorption region in dark color for better comparison with H&E images. FIGS. 17A and 17B are examples of images to show a comparison between the original grayscale image and the image in reversed contrast. FIG. 17A is an example UV-PAM image of a decalcified bone specimen from a patient with moderately differentiated metastatic pulmonary adenocarcinomain in the original grayscale contrast. FIG. 17B is another example of the UV-PAM image of the decalcified bone specimen of FIG. 17A in reversed grayscale contrast.

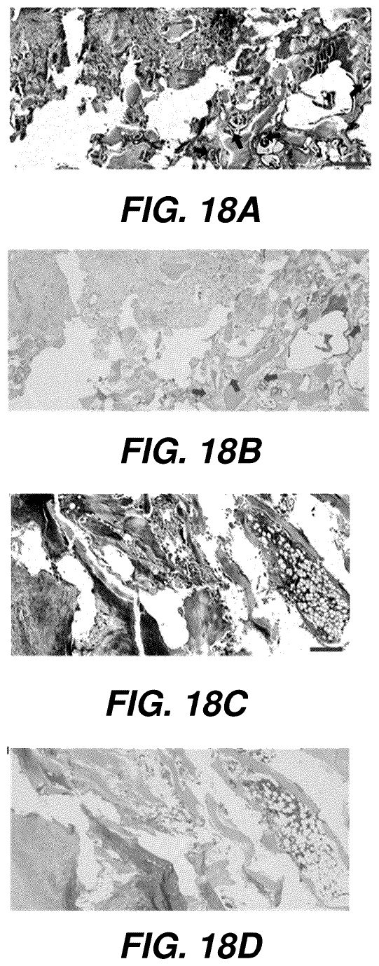

The decalcified bone specimen extracted from a patient with metastatic adenocarcinoma was imaged by 3D contour scanning using UV-PAM system 200 from FIG. 2 and compared with its corresponding H&E images. FIG. 18A is an example 3D contour-scanning UV-PAM image in reversed grayscale contrast of a decalcified bone specimen extracted from a patient with metastatic adenocarcinoma, according to some embodiments. FIG. 18C is an example 3D contour-scanning UV-PAM image in reversed grayscale contrast of the decalcified bone specimen of FIG. 18A with normal bone fragment and hematopoietic marrow, according to some embodiments. FIG. 18B is an example H&E image corresponding to the UV-PAM image of FIG. 18A. FIG. 18D is an example H&E image corresponding to the UV-PAM image of FIG. 18B. The UV-PAM image in FIG. 18A shows nearly identical features to the corresponding H&E-stained image in FIG. 18B, in which abnormal tumor glands are readily observable (indicated by arrows). The UV-PAM image in FIG. 18C of a decalcified fragments of bone and hematopoietic marrow with no evidence of metastatic carcinoma also shows the same structure as its corresponding H&E image in FIG. 18D. Furthermore, the undecalcified bone slices were imaged by UV-PAM techniques, which may avoid potential artifacts introduced by the decalcification procedures. Since these specimens were harvested from a portion of the tumor with low calcification, they did not require the decalcification procedure to section the specimen into thin slices.

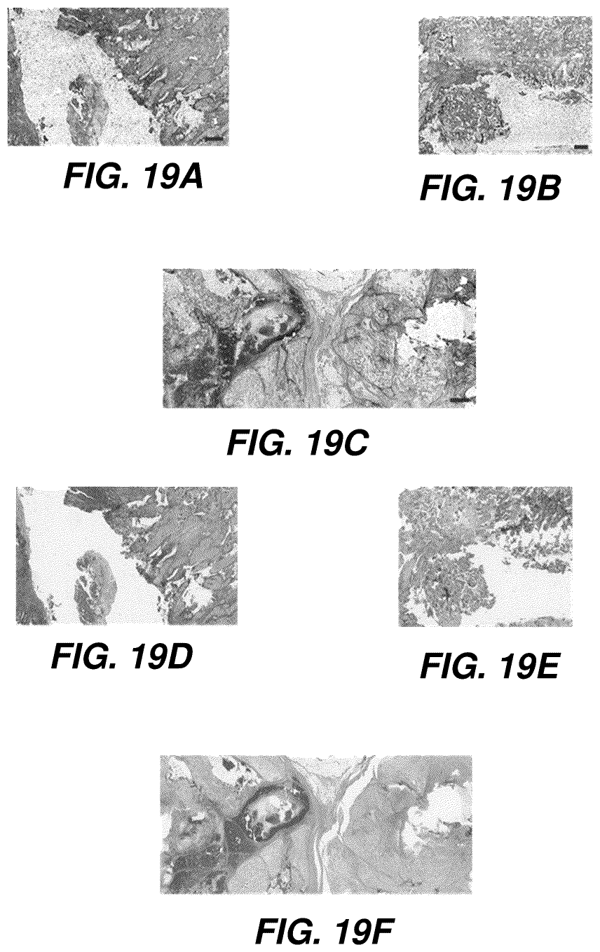

FIG. 19A is an example 3D contour-scanning UV-PAM image in reversed grayscale contrast of an undecalcified bone specimen, according to some embodiments. FIG. 19B is another example 3D contour-scanning UV-PAM image in reversed grayscale contrast of the undecalcified bone specimen of FIG. 19A, according to some embodiments. FIG. 19C is another example 3D contour-scanning UV-PAM image in reversed grayscale contrast of the undecalcified bone specimen of FIG. 19A. FIG. 19D is an example H&E image corresponding to the UV-PAM image of FIG. 19A. FIG. 19E is an example H&E image corresponding to the UV-PAM image of FIG. 19B. FIG. 19F is an example H&E image corresponding to the UV-PAM image of FIG. 19C. The corresponding H&E images were acquired by a digital whole slide scanning microscope with a 40× objective. The H&E images show nearly identical structures as the UV-PAM images.

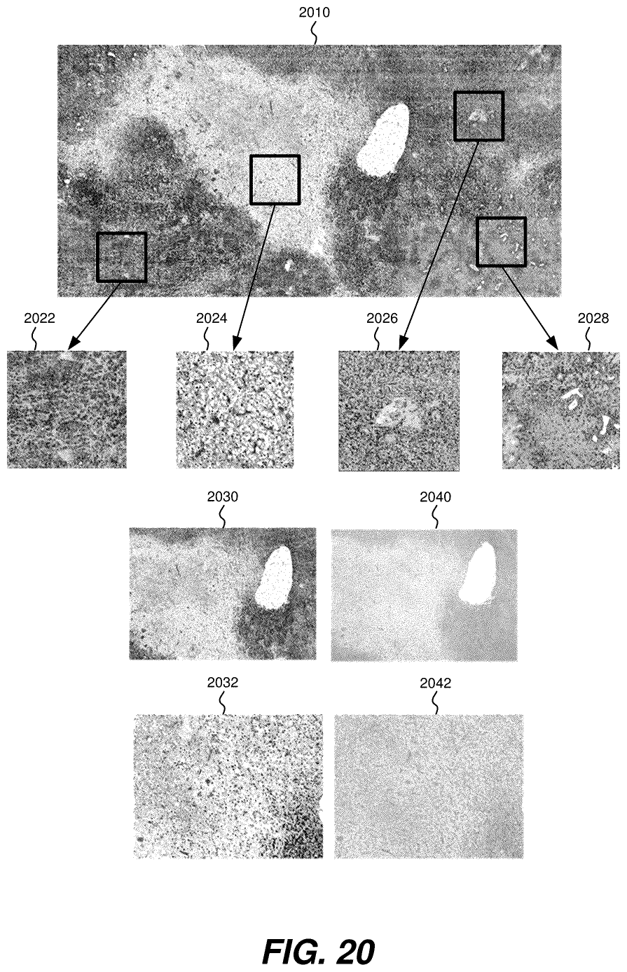

FIG. 20 depicts example images of a decalcified bone slice with high-grade osteosarcoma from a femur acquired by 3D contour scanning using 3D contour-scanning UV-PAM system according to some embodiments, and corresponding H&E close up images. The images include a 3D contour-scanning image 2210 of the decalcified bone slice with high-grade osteosarcoma from a femur, a closeup 3D contour-scanning image 2222 showing the necrotic tumor, closeup 3D contour-scanning images 2224, 2226, and 2228 showing the viable tumor, closeup 3D contour-scanning images 2030, 2032, and closeup H&E images 2240 and 2242 corresponding to closeup 3D contour-scanning images 2030 and 2032.

UV-PAM with Virtual Staining Using Deep Learning

To reconstruct the UV-PAM images, the photoacoustic (PA) amplitude of each A-line signal is calculated after the Hilbert transform. The pulse energy measured by the photodiode may be used to normalize the PA amplitude and compensate for laser pulse fluctuation. The axial position of the specimen surface may be calculated by detecting the peak of the A-line signal after the Hilbert transform. The 2D MAP (maximal amplitude projection) image was self-normalized. Since PA amplitude of the contrast is proportional to its absorption cross-section, the UV-PAM image may be used to potentially differentiate cell nuclei, cytoplasm, and the background. The cell nuclei have the largest absorption coefficient at 266 nm and the highest PA signals. After constructing the one or more grayscale images, a trained neural network may be used to perform virtual H&E staining to form corresponding one or more virtually stained color images.

A cycle-consistent GAN (CycleGAN) architecture may be used, which can learn how to map images from the UV-PAM domain, PA, to the H&E domain, HE, without the need for well-aligned image pairs. An adversarial loss may be used to learn the transformation G: PA→HE, such that the images G(PA) are indistinguishable from HE. To ensure the UV-PAM images are of the same structures, the inverse transformation F: HE→PA may also be learned and a cycle consistency loss may be used to give F(G(PA))»PA and G(F(HE))»HE. The generators are residual networks consisting of an input convolutional layer, two convolutional layer and downsampling blocks, nine residual network blocks, two convolutional and upsampling blocks, and finally, an output convolutional layer. For the discriminator, in some embodiments, a GAN can be used including one or more convolutional layers and one or more downsampling layers, which classify whether the image is real on overlapping pixel image patches (e.g., 70×70 patch size). This patch size is a compromise between promoting high spatial frequency fidelity and avoiding tiling artifacts. The network parameters may be updated and optimized by minimizing one or more losses, e.g., the least-squares adversarial loss and/or the cycle consistency loss.

The training dataset consisted of UV-PAM images of undecalcified bone specimens. These images were converted into 17940 and 26565 286×286 pixel image patches for UV-PAM and H&E histology, respectively. During training, these were further randomly cropped to 256×256 for data augmentation. The training may be performed with the Adam solver with a batch size of 4 and an initial learning rate of 0.0002, decaying to zero over 100 epochs. Once trained, the generator G can be used to transform UV-PAM data in overlapping 256×256 pixel image patches, which were recombined with linear blending.

To match traditional histology images, virtual H&E staining on the grayscale UV-PAM images using a cycle-consistent GAN based deep learning method was performed to generate virtually H&E-stained color UV-PAM images. The virtual staining GAN network architecture implemented is shown in FIG. 4. Details of the procedures for generating virtually H&E-stained PAM images from grayscale UV-PAM images are described in Section IV.

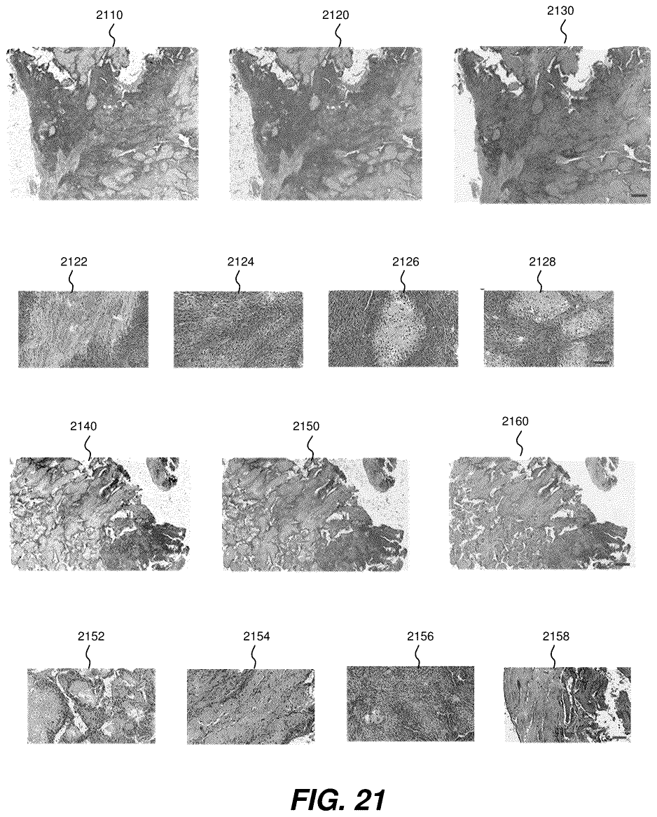

FIG. 21 depicts example 3D contour scanning UV-PAM grayscale images and corresponding virtually stained color (i.e. pseudocolor including one or more colors) UV-PAM images (e.g., histology-like images) according to some embodiments, and also H&E images of an undecalcified bone fragment specimen, according to some embodiments. The depicted images include 3D contour scanning UV-PAM grayscale images 2110 and 2140 of an undecalcified bone specimen, virtually-stained color UV-PAM images 2120 and 2150 corresponding to UV-PAM grayscale images 2110 and 2140, and H&E stained images 2130 and 2160 corresponding to the virtually-stained color UV-PAM images 2120 and 2150 with scale bar 500 μm. The depicted images also include closeup virtually-stained color UV-PAM images 2122, 2124, 2126, and 2128 of virtually-stained color UV-PAM image 2120 with scale bar 100 μm. The depicted images also include closeup virtually-stained color UV-PAM images 2152, 2154, 2156, and 2158 of virtually-stained color UV-PAM image 2150 with scale bar 100 μm. The virtually-stained color UV-PAM images 2130 and 2160 show differentiation of the cytoplasm and the cell nuclei similar to the corresponding H&E images 2130 and 2160. The closeup virtually-stained color UV-PAM images 2122, 2124, 2126, 2128, 2152, 2154, 2156, and 2158 show pathological features that may be used for intraoperative diagnosis of bone tumor.

The development of 3D contour-scanning UV-PAM in reflection mode provides the possibility for rapid pathological examination of bone specimens since it avoids excessive specimen preparation. In contrast, traditional pathological examination techniques for bone involve time-consuming decalcification procedures, and the frozen section technique is not applicable. With the bone mineral as its major component, dense cortical bones can take days to decalcify before it is soft enough to be sectioned into thin slices, which prevents rapid intraoperative diagnosis. Currently, orthopedic surgeons rely heavily on pre-operative CT scans or MRI to identify the bony edge of resection. But these imaging modalities cannot provide accurate diagnosis and intraoperative confirmation of tumor margins. Reflection-mode contour-scanning UV-PAM techniques may provide label-free imaging of unprocessed thick bone samples with rough surfaces, which may provide detailed information for pathological diagnosis and may provide the possibility to identify the tumor margin rapidly, for intraoperative margin analysis.

To diagnose using gold standard H&E histological images, pathologists may examine the morphology and structural distribution of cell nuclei, cytoplasm, and extracellular matrix. H&E staining provides contrast between cell nuclei and cytoplasmic parts by staining them in different colors. Thus, pathologists are trained to use color images of stained tissue samples, which show extracellular matrix and cytoplasm in pink and cell nuclei in blue/purple. At the UV wavelength of 266 nm36, the cell nuclei have a much higher absorption coefficient and PA amplitudes than the extracellular matrix and cytoplasm, allowing the virtual labeling in different colors like H&E staining. The grayscale UV-PAM images were processed and the pseudocolor (one or more colors) for virtual H&E staining was generated by applying the deep learning approach with cycle-consistent GAN, which does not need well-aligned UV-PAM and H&E image pairs for neural network training. The virtually stained pseudocolor UV-PAM images showed abundant detail of cell nuclei and cytoplasm, matching the corresponding H&E images.

In one embodiment, a UV-PAM technique may employ photoacoustic tomography (PAT) to detect either endogenous or exogenous contrast-induced ultrasound signals through light absorption. Wavelength-dependent absorption may allow for quantitative measurements of the concentration and distribution of different optical absorbers, while the less scattering ultrasound detection enables high-resolution deep tissue imaging. The unique advantage of scalable spatial resolutions and imaging depths makes this implementation useful for various applications, ranging from imaging of nanometer-scale mitochondria to millimeter-level blood vessels in deep tissue. Based on the imaging resolution and reconstruction approaches, PAT can be implemented in the UV-PAM techniques.

Although certain examples of UV-PAM techniques are described as employing UV illumination of certain wavelengths, the 3D contour scanning process may be implemented with illumination of other wavelengths according to other embodiments. For example, the UV-PAM system 100 may include an illumination source emitting a different wavelength to excite the specimen. Depending on the illumination wavelength, various contrasts may be imaged using these implementations, including but not limited to hemoglobin, DNA/RNA, cytochrome, water, lipid, and protein.

In one embodiment, UV-PAM techniques implement the nonlinear absorption or Grüneisen parameter.

In one embodiment, the UV-PAM system employs a pulsed 266 nm laser with a pulse repetition rate of up to 50 kHz. In one embodiment, pulse repetition rates of higher than 50 kHz are used and the UV-PAM system includes a one-dimensional galvanometer mirror to improve the speed of optical scanning.

In one embodiment, multichannel parallel imaging can be implemented by a UV-PAM system to improve imaging speed by implementing multiple focal spots and an ultrasound transducer array for image reconstruction. For instance, a microlens array can be utilized to create multiple focal spots for multichannel parallel imaging, may improve the imaging speed of UV-PAM.

In one embodiment, a UV-PAM system may include an electrically tunable lens (ETL) may for faster optical focus shifting with high accuracy. Since the acoustical DOF of the focused ultrasonic transducer is often much longer (i.e., hundreds of microns) than the optical DOF, the optical focus shifting within the acoustic DOF can be used to compensate for the steep height fluctuation, while the time-dependent gain compensation technique can be used to compensate for the transducer sensitivity difference within the acoustic DOF.

In one embodiment, a UV-PAM system may include a light source for emitting one or more non-diffracting beams. A non-diffracting beam may have an extended optical DOF with reduced side lobes. With the extended optical DOF of the one or more non-diffracting beams, the UV-PAM system may have a large tolerance for height fluctuations.

Although many examples are described herein with respect to imaging bone tissues, it would be understood that other biological tissues and other types of specimen may be imaged using UV-PAM techniques.

Modifications, additions, or omissions may be made to any of the above-described implementations without departing from the scope of the disclosure. Any of the implementations described above may include more, fewer, or other features without departing from the scope of the disclosure. Additionally, the steps of described features may be performed in any suitable order without departing from the scope of the disclosure. Also, one or more features from any implementation may be combined with one or more features of any other implementation without departing from the scope of the disclosure. The components of any implementation may be integrated or separated according to particular needs without departing from the scope of the disclosure.

It should be understood that certain aspects described above can be implemented in the form of logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code using any suitable computer language and/or computational software such as, for example, Java, C, C#, C++ or Python, Lab VIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM), a read only memory (ROM), a magnetic medium such as a hard-drive or a floppy disk, or an optical medium such as a CD-ROM, or solid stage storage such as a solid state hard drive or removable flash memory device or any suitable storage device. Any such CRM may reside on or within a single computational apparatus, and may be present on or within different computational apparatuses within a system or network. Although the foregoing disclosed implementations have been described in some detail to facilitate understanding, the described implementations are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain implementations herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or implementations of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

What is claimed is:

1. A three-dimensional contoured scanning photoacoustic apparatus, comprising:
an optical system configured to direct at least a first portion of a pulsed laser beam to a specimen being imaged;
an ultrasonic transducer device configured to detect one or more photoacoustic signals induced by the at least the first portion of the pulsed laser beam; and
a three-dimensional contour scanner configured to scan the specimen and/or the ultrasonic transducer device to compensate in real-time for three-dimensional contour in a surface of the specimen using time of flight data of the one or more photoacoustic signals.

2. The three-dimensional contoured scanning photoacoustic apparatus of claim 1, wherein the three-dimensional contour scanner is configured to perform a plurality of 2D photoacoustic scans of the specimen comprising a seed 2D photoacoustic scan and one or more contour 2D photoacoustic scans, wherein each of the contour 2D photoacoustic scans is performed based at least in part on axial compensation steps calculated using time of flight data of one or more photoacoustic signals detected during a previous adjacent 2D photoacoustic scan of the plurality of 2D photoacoustic scans.

3. The three-dimensional contoured scanning photoacoustic apparatus of claim 2, wherein the seed 2D photoacoustic scan is performed without axial compensation.

4. The three-dimensional contoured scanning photoacoustic apparatus of claim 2, further comprising:
a photodiode configured to measure pulse energy, wherein the optical system is further configured to propagate a second portion of the pulsed laser beam to the photodiode; and
a computing system and/or a controller, configured to construct one or more grayscale images of the specimen based at least in part on (i) time of flight data from the one or more contour 2D photoacoustic scans and (ii) one or more photodiode measurements of pulse energy of the pulsed laser beam.

5. The three-dimensional contoured scanning photoacoustic apparatus of claim 4, wherein the computing system and/or a controller is further configured to perform virtual staining of the one or more grayscale images to form one or more virtually stained color images.

6. The three-dimensional contoured scanning photoacoustic apparatus of claim 1, wherein the pulsed laser beam is an ultraviolet pulsed laser beam.

7. The three-dimensional contoured scanning photoacoustic apparatus of claim 1, wherein the three-dimensional contour scanner is configured to scan along three axes.

8. The three-dimensional contoured scanning photoacoustic apparatus of claim 1, wherein the three-dimensional contour scanner comprises a three-axis motorized stage.

9. A three-dimensional contoured scanning photoacoustic method, comprising real-time three-dimensional contoured photoacoustic scanning of a surface of a specimen using time of flight data.

10. The three-dimensional contoured scanning photoacoustic method of claim 9, wherein the real-time three-dimensional contoured photoacoustic scanning comprises:
performing a plurality of 2D photoacoustic scans of the specimen comprising a seed 2D photoacoustic scan and one or more contour 2D photoacoustic scans,
wherein each of the contour 2D photoacoustic scans is performed based at least in part on axial compensation steps calculated using time of flight data of one or more photoacoustic signals detected during a previous adjacent 2D photoacoustic scan of the plurality of 2D photoacoustic scans.

11. The three-dimensional contoured scanning photoacoustic method of claim 10, wherein the seed 2D photoacoustic scan is performed without axial compensation.

12. The three-dimensional contoured scanning photoacoustic method of claim 10, wherein each of the contour photoacoustic 2D scans is performed using a 3D contour scanner to scan the specimen according to the axial compensation steps.

13. The three-dimensional contoured scanning photoacoustic method of claim 10, further comprising:
extracting a profile curve of the specimen from time of flight data of one or more photoacoustic signals detected during the previous adjacent 2D photoacoustic scan; and
calculating the axial compensation steps based at least in part on the profile curve.

14. The three-dimensional contoured scanning photoacoustic method of claim 10, further comprising:
constructing one or more grayscale images of the specimen using one or more photoacoustic signals detecting during the one or more contour 2D photoacoustic scans.

15. The three-dimensional contoured scanning photoacoustic method of claim 14, further comprising virtual staining the one or more grayscale images to form one or more virtually stained color images.

16. A method of virtually staining one or more histology images, the method comprising:
training a first machine learning model by:
inputting a first histology image obtained using a first histological technique to the first machine learning model to generate a first predicted image having a characteristic of a second histological technique;
inputting the first predicted image to a second machine learning model configured to generate a second predicted image having a characteristic of the first histological technique; and
based on an error associated with the first histology image and the second predicted image, updating one or both of the first machine learning model or the second machine learning model;
inputting, to the trained first machine learning model, a second histology image obtained using the first histological technique; and
generating, using the trained first machine learning model, a virtually stained histology image based on the second histology image, the virtually stained histology image having a characteristic of the second histological technique.

17. The method of claim 16, wherein the training of the first machine learning model further comprises:
inputting the first predicted image to a third machine learning model corresponding to the first machine learning model, the third machine learning model configured to determine a first metric indicative of a likelihood of the first predicted image having been obtained using the second histological technique; and
inputting the second predicted image to a fourth machine learning model corresponding to the third machine learning model, the fourth machine learning model configured to determine a second metric indicative of a likelihood of the second predicted image having been obtained using the first histological technique.

18. The method of claim 17, wherein:
the first machine learning model comprises a first generator;
the second machine learning model comprises a second generator;
the third machine learning model comprises a first discriminator corresponding to the first generator; and
the fourth machine learning model comprises a second discriminator corresponding to the second generator.

19. The method of claim 17, wherein:
the first metric and the second metric each comprises a respective range of values between a first value and a second value, the first value indicative of a predicted image having been obtained using the first histological technique, the second value indicative of the predicted image having been obtained using the second histological technique; and
the updating of the one or more of the first machine learning model or the second machine learning model comprises optimizing one or more of the first metric or the second metric to approach a midpoint of the respective range of value.

20. The method of claim 19, wherein the respective range of values is between 0 and 1, inclusive, and the midpoint is 0.5.

21. The method of claim 16, wherein the first histological technique comprises photoacoustic imaging, and the second histological technique comprises hematoxylin and eosin staining.

22. The method of claim 21, wherein the photoacoustic imaging comprises:
performing a plurality of 2D photoacoustic scans comprising a seed 2D photoacoustic scan and one or more contour 2D photoacoustic scans,
wherein each of the contour photoacoustic 2D scans is performed based at least in part on axial compensation steps calculated using time of flight data of one or more photoacoustic signals detected during a previous adjacent photoacoustic 2D scan of the plurality of photoacoustic 2D scans.

23. The method of claim 16, wherein the virtually stained histology image comprises the characteristic of the second histological technique and obtained without using the second histological technique, the characteristic comprising at least one color.
